(19) United States
(12) Patent Application Publication
(10) Pub. No.: US 2002/0181831 A1
(43) Pub. Date: Dec. 5, 2002

(54) Tamed spectrum multiplexing

(76) Inventors: Michael H. Myers, Poway, CA (US); Clark C. Guest, San Diego, CA (US)

Correspondence Address: ALL OPTICAL NETWORKS, INC., 9440 CARROLL PARK DRIVE, SAN DIEGO, CA, 92121, US

(21) Appl. No.: 09/872,406

(22) Filed: Jun. 1, 2001

(51) Int. Cl. G02B 6/28; G02B 6/26

(52) U.S. Cl. 385/15; 385/24

(57) ABSTRACT

A particular signal from a legacy photonic source may have a distribution of wavelengths in a particular signal that is excessively broad for modern, narrowband equipment. In order to provide a drop-in apparatus for integrating modem narrowband signal carrying and handling devices with legacy equipment as either sender or receiver, various implementations of a data stabilizer are provided. Data stabilizers may rely on information transfer mechanisms, signal directors, wavelength shifters, cross-gain modulation, cross-phase modulation, and four-wave mixers. Moreover, data stabilizers may be implemented directly as multiplexers, or integrated into systems using conventional multiplexers.

### BACKGROUND

1. The Field of the Invention

This present invention relates to communication networks, and more specifically to methods and apparatus for stabilization of photonic data in order to narrow bandwidth requirements for channels in multiplexed or other transmission systems.

2. Background

Legacy sources of photonic signals are typically lasers, light emitting diodes, microwave transmitters, and the like. Traditionally, legacy photonic systems suffer from various limitations on the precision of the characteristic parameters for a given signal. For example, lasers often produce a comparatively broad spectral output of a light signal. In certain circumstances, lasers or other photonic sources may drift from one frequency to another over a comparatively broad range of frequencies.

Often, since light is electromagnetic radiation dependent upon the theories of quantum mechanics, the selection of a frequency of emission is actually a quantum event. Accordingly, frequencies may actually hop. Frequency hopping in a photonic source may also be a direct result of certain geometries or chemistries that produce substantially equivalent probability, desirability, or physical possibility for generation of signals at multiple frequencies. Accordingly, frequency hopping may exist, causing a requirement to observe, track, accommodate, or assign a comparatively large bandwidth to each signal or channel being relied upon.

Typically, a signal does not contain energy at a single frequency. A modulated signal may include several frequencies. Often, legacy photonic sources have comparatively large deviations from a main frequency intended, desired, or nominally rated for a particular device.

Wavelength stabilization or wavelength shifting is needed. However, according to technical experts writing in the photonic industry, semiconductor laser diodes exhibiting multi-mode behavior are not considered suitable for applications requiring extended distance of transmission, or for applications requiring wavelength (frequency) multiplexing. Moreover, some writers characterize attempts at wavelength conversion as being laboratory curiosities, having no practical implementations known in commercial products or systems.

The result of the variation in the actual spectral output of a legacy photonic source, when compared to the desired or nominal value, is excessive use of available wavelength (frequency) ranges (bandwidth) required to be allocated to a particular channel or line of data. In order to improve the situation, either more equipment is required, or replacement of old equipment with newer more precise equipment is required. Both options amount to expense, substantial expense.

Accordingly, telecommunication systems can become bandwidth limited. Moreover, typically, the actual photonic transmission medium (e.g. light fiber, etc.) can carry substantially more information than the equipment attached to each end can send or receive. Thus, the capacity of conventional fiber transmission systems could be substantially improved if the signal generation, signal management, multiplexing, de-multiplexing, detection, etc. equipment could be improved to operate within a narrower, more reliable range (bandwidth) of wavelength of frequencies.

One benefit to using the current carrier medium with a more finely subdivided date bandwidth is the substantial increase of useable information bandwidth. The alternative, is to lay more cable, (fibers) in order to support more end equipment for sending and receiving signals.

Several difficulties arise from the incompatibility of receivers with either the carrier medium, or a legacy photonic source. For example, a legacy photonic source is extremely expensive to replace. Thus, a more modern receiving mechanism, capable of carrying more channels in a given range of frequencies, cannot benefit therefrom if the original sources of data do not support the narrower bandwidths.

Similarly, a modern transmitting device cannot interface with legacy receiving equipment if the receiving device cannot provide the precision to distinguish signals within their comparatively narrow bands. Meanwhile, legacy equipment may be incompatible with carriers in that one component mismatched with another (e.g. in capacity), wastes the capacity of the underutilized element. Meanwhile, the great expense remains for upgrading each successive bottleneck in the transmission and receiving processes.

Thus, in general, having a mismatch of legacy equipment whether sending devices or receiving devices, in combination with either a modern narrow band sender or receiver, in view of the capacity of installed carrier media, results in either wasted capacity or expensive replacement of existing equipment.

What is needed is a mechanism for providing narrowing of bandwidth requirements. This would best be accomplished if such a device could “drop-in” its modern, narrow-bandwidth capabilities within legacy networks.

### BRIEF SUMMARY AND OBJECTS OF THE INVENTION

The foregoing difficulties are overcome by data stabilization in accordance with the invention. In certain embodiments of an apparatus and method in accordance with the present invention, information may be transferred from one or more signals to an output signal that is easily phase locked with a carrier signal. Various photonic devices, including photonic transistors may be used to accomplish this end. Photonic amplifiers may provide amplification, preferentially in a single direction, suppressing amplification in an opposite direction.

Specific devices selected may rely on gas, dye, semiconductors, crystalline materials, or the like to provide the disparate amplification properties. For example, an amplifier having finite gain, when provided a continuous wave signal in one direction, will amplify the signal. A signal in the opposite direction, when its level reaches the reversing level of the device, loses energy from the process of amplification, causing reduced output.

Such a process provides an inverting function having a comparatively wide, frequency band pass for a modulated input, while transferring information in an inverted form to the frequency of a continuous wave bias signal. Since the signal is available for use by other local photonic circuitry, the output may be phase locked to the external photonic circuitry.

Applications for such an apparatus may include interfacing optical signals, such as those in the fiber of a legacy transmission system, in order to match to localized photonic circuitry in a transmitter or receiver. Provisioning and other processes that require allocation of frequencies may benefit from the transfer of information from one wavelength to another. Accordingly, a wavelength-division-multiplexing system may be operated more efficiently. Such a mechanism may operate for routing and controlling the signals to and from photonic devices.

One may think of a reversing level as a threshold function having multiple uses. For example, multiple inputs may sum to exceed the threshold in order to provide a multiple-input, multiple-frequency, multiple-phase logical AND device. Such a device provides a standardized output frequency. Multiple inputs, each having an intensity above such a threshold may provide a multiple-input, multiple-frequency, multiple-phased logical OR device.

In certain alternative embodiments, an amplifier may be part of a ring resonator or ring laser. The threshold function may be enhanced or modified by the lasing action existing within the ring resonator.

In one embodiment of an apparatus and method in accordance with the invention a silicon optical amplifier (SOA) may be used in a way dissimilar to it's design performance. For example, the SOA may receive a single line laser output at a wavelength selected by a user. A control beam may be used to modulate the SOA with another laser.

The refractive index of the original SOA is changed by the laser source being modulated to embody data. The change in refractive index alters the gain of the SOA. Thus, the output of the SOA is inverted, and the gain will change with the data rate of the original source. A continuous wave reference laser used in such an arrangement may benefit by changing the bias point of the SOA. Some gain may be degraded, but the base band may be cleaned up somewhat. Also, since the data rate is governed by the gain, high data rates increase the gain and the SOA.

In one embodiment of a method and apparatus in accordance with the invention, modulated data from a photonic source within an initial transmission band may be modulated onto another photonic source having a different characteristic wavelength. One way to accomplish the effect is to rely on dual, optical, cross-modulation, utilizing some active media. For example, an SOA may serve well in this application.

Data modulated onto an initial photonic source may be passed, by way of a circulator into an active medium. The active medium, such as an SOA, may receive, in an opposite direction, a carrier signal from another photonic source (e.g. laser). The carrier signal from the second photonic source is modulated in the active medium, transferring the data from the original photonic source, onto which the data was modulated, into the new laser carrier at a different characteristic wavelength.

The newly modulated photonic signal (modulated carrier) may then pass through two circulators to an optical filter. The filter process suppresses residual light from the original photonic source of data. The output of the circulator to which the filter returns it's output contains all of the data originally provided, but not modulated onto the laser carrier frequency of the new photonic source. Due to the SOA operation, the new or final output is inverted with respect to the original photonic data source. Various processes, including replication of the cross-modulation process just described may be used to restore the original signal.

In one embodiment, a signal from a legacy photonic data source may pass by way of a circulator through an SOA. Meanwhile, a signal from a reference photonic source (e.g. carrier, continuous wave laser, etc.) May pass through the SOA in an opposite direction. Data is cross-modulated onto the signal from the reference photonic source. The reference source signal having the data modulated onto it, passes by way of two circulators to an optical filter in order to attenuate or otherwise reject residual light from the legacy data source.

This process may be repeated with additional reference lasers, additional pairs of circulators, a corresponding SOA, and a corresponding filter. Accordingly, the output signal may be transmitted to a receiver remote therefrom, having been re-inverted by the second referential source and SOA.

In yet another alternative embodiment, a wavelength conversion may be executed by a transmitter device or system, being followed by a second conversion accomplished at a remote receiver. Such a process may provide a certain degree of encryption, as well as additional data channels by virtue of inversion during transmission.

In certain embodiments, a method and apparatus in accordance with the invention may provide repeatability of phase, frequency, or both relationships between an output of a photonic source and a reference source after one or both are shut down and restarted. Stabilization of phase and frequency relationships are important, but may be difficult.

In one embodiment, phase, frequency or both relationships between an electromagnetic oscillator (e.g. laser, etc.) and an outside system of photonic circuitry may be maintained, although the oscillator is off. Moreover, a method and apparatus in accordance with the invention may reestablish this same frequency and phase relationships once the oscillator portion starts up again.

A comparatively modest level of energy from a seed reference signal may be directed into an amplifier of an oscillator. When the oscillator is energized or modulated into an “on”state, the amplifier adds energy to the existing phase established by the seed signal. As amplification continues, the oscillator becomes fully energized. During the rise time, the additional energy becomes tuned to the frequency and phase of the seed reference. Accordingly, when full power is achieved, the signal is “synchronized” in phase and frequency with the seed reference signal. Regardless of the method of energizing the oscillator, whether optically, electronically, mechanically, or switched, the seeding process succeeds.

In one embodiment of an apparatus and method in accordance with the invention, a tamed spectrum multiplexing process may be executed in order to facilitate multiplexing of a legacy light source having an original wavelength band. Such sources (e.g. Fabry Perot laser systems) typically exhibit multi-mode, wideband, time-variant, spectral characteristics detrimental to multiplexing.

Semiconductor laser diodes exhibiting multi-mode behavior are not considered suitable for transmission applications requiring extended distances, nor for applications requiring multiplexing. Undesirable properties of the mode behavior typical semiconductor lasers, results in broad spectral signals, mode hopping, and so forth.

In an apparatus in accordance with the invention, hopping is suppressed while dispersion is decreased, increasing the range of transmission. Moreover, higher numbers of channels may be multiplexed together, due to the narrowed bandwidth requirements of each corresponding signal.

In one embodiment, feedback to a remotely located legacy device providing modulated data may provide a single mode photonic signal (e.g. light). Excitation of the legacy photonic source effectively collapses the output spectrum thereof into a signal mode near or at the frequency at the excitation source (seed). Accordingly, various benefits are provided. For example, cross bar switching, and thus, remote provisioning, becomes tractable. A simple interchange of the carrier frequencies of filters tunable in accordance with a multiplexing scheme at the receiver end facilitates the process.

In one embodiment of an apparatus and method in accordance with the invention, an active medium, such as an SOA, may provide a reference photonic source. The reference signal may be fed to legacy photonic sources originating a modulated photonic signal. Accordingly, certain spectral components may be substantially exclusively generated and relied upon for transmission of data.

For example, a selected region of the spectrum may be provided, having a substantially narrower bandwidth than the transmitting or receiving bandwidth of a legacy photonic device. Spontaneous emission from the SOA is transmitted to a filter, such as a grating or a reflecting Bragg filter. The reflective portion of the signal passed through the SOA causes an amplification of the selected wavelength reflected from the filter.

Meanwhile, the passband signal goes on to some place elsewhere. The result is a suppression of the spontaneous initial frequencies not consistent with the reflection band of the filter.

The output of the filtered signal, after passing back through the SOA, may return to a circulator intermediate the legacy photonic source and the SOA. Accordingly, the legacy photonic source is stimulated or seeded at the selected wavelength. The output of the legacy photonic source is ultimately provided as an output of the circulatory. Because the filtered signal is so narrowed, and amplified by the SOA during the return pass, power levels may be substantial to stimulate the legacy photonic source.

Broadband tuneability in lasers is difficult and expensive, if possible at all. Typically, complex dye lasers must be relied upon for such mechanisms. Such a massive physical plant is hardly suitable for integration in small scale telecommunications devices. Thus, broadband sources are extremely difficult to come by. Meanwhile, narrowband filters, tunable over a broad range of operation are likewise extremely difficult to come by. In a method and apparatus in accordance with the invention, the presence of either one facilitates the ability to obtain the benefits of the other.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of a communications system relying on a photonic data stabilizer in accordance with the invention;

FIG. 2 is a schematic block diagram of one alternative embodiment of an apparatus for implementing a photonic data stabilizer in accordance with the invention;

FIG. 3 is a schematic block diagram of an alternative embodiment of a data stabilizer;

FIG. 4 is a schematic block diagram of another alternative embodiment of a data stabilizer;

FIG. 5 is a schematic block diagram of one embodiment of a multiplexing and demultiplexing telecommunications system relying on a photonic data stabilization system;

FIG. 6 is a schematic block diagram of an alternative embodiment of an integrated, stabilizing multiplexer utilizing data stabilization in accordance with the invention to form a multiplexer;

FIG. 7 is a schematic block diagram of a stabilization system controlled by an external control mechanism in accordance with the invention;

FIG. 8 is a schematic block diagram of a heterogeneous multiplexing system integrating both stabilized multiplexing and other photonic sources;

FIG. 9 is a schematic block diagram of one embodiment of an information-transfer type of photonic data stabilizer;

FIG. 10 is a schematic block diagram of an alternative embodiment of an information-transfer of type photonic data stabilizer;

FIG. 11 is a schematic block diagram of an alternative embodiment of an information-transfer of type photonic data stabilizer;

FIG. 12 is a schematic block diagram of a polarization-separated, information-transfer mechanism in a data stabilizer in accordance with the invention;

FIG. 13 is a graph illustrating comparative signals in an apparatus in accordance with the invention;

FIG. 14 is a schematic block diagram of an active-medium type of data stabilizer in accordance with the invention;

FIG. 15 is a schematic block diagram of multiple data stabilizers in series providing reversal of signal inversion processes in accordance with the invention;

FIG. 16 is a schematic block diagram of photonic data stabilizers implemented at both the sending and receiving ends of a telecommunications network;

FIG. 17 is a schematic block diagram of an alternative embodiment of a photonic data stabilizer relying on a seed reference source to control a combiner to stabilize phase and frequency;

FIG. 18 is a schematic block diagram of an alternative embodiment of a data stabilizer using modulated information to switch a laser source feeding a beam into the data stabilizer;

FIG. 19 is a schematic block diagram of a ring-type, data stabilizer relying on both a modulated, switched source and a seed source as a reference;

FIG. 20 is a schematic block diagram of a circulator-based, data stabilizer relying on a tunable filter and illustrates the graphs of the wavelength distributions;

FIG. 21 is a schematic block diagram of an alternative embodiment of a data stabilizer using an active medium between a filter and circulator;

FIG. 22 is a schematic block diagram of an alternative embodiment of a data stabilizer relying on a VCSEL;

FIG. 23 is a schematic block diagram of an alternative embodiment of a data stabilizer relying on tunable filtering, active medium amplification, and a Fabry Perot laser source;

FIG. 24 is a schematic block diagram of one alternative embodiment of a four-port circulator used in a data stabilizer in accordance with the invention;

FIG. 25 is a schematic block diagram of one embodiment of a stabilized multiplexing system and demultiplexing system;

FIG. 26 is a schematic block diagram of an alternative embodiment of a combiner system operating to multiplex, and a microprocessor-controlled data-stabilizer system, as a demultiplexing method;

FIG. 27 is a schematic block diagram of one embodiment of a microprocessor-controlled, multiplexing end of a stabilized photonic multiplexing apparatus in accordance with the invention;

FIG. 28 is a schematic block diagram of one embodiment of a wavelength shifter for use as a data stabilizing mechanism;

FIG. 29 is an alternative embodiment of a data-stabilization mechanism relying on a four-wave mixer;

FIG. 30 is a schematic block diagram of an alternative embodiment of a data stabilizer relying on a cross-gain modulator;

FIG. 31 is a schematic block diagram of a cross-phase modulator for implementing a photonic data stabilizer in accordance with the invention; and

FIG. 32 is a schematic block diagram of one embodiment of a demultiplexer relying on a controller implemented in a data stabilizer to provide the demultiplexing end of a multiplexing-demultiplexing system.

### DETAILED DESCRIPTION OF THE PREFERRED EMBODIMENTS

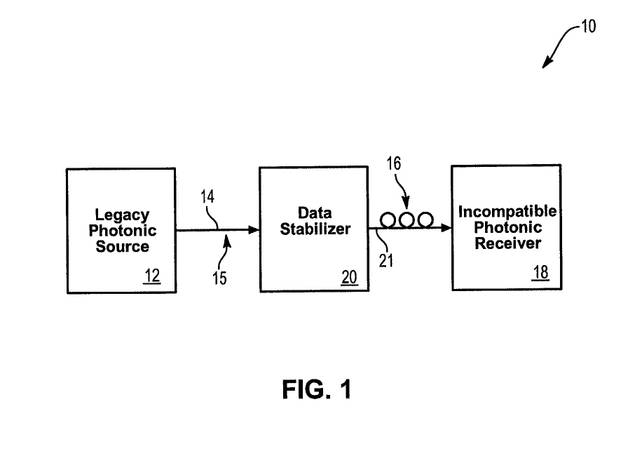

It will be readily understood that the components of the present invention, as generally described and illustrated in the Figures herein, could be arranged and designed in a wide variety of different configurations. Thus, the following more detailed description of the embodiments of the system and method of the present invention, as represented in FIGS. 1 through 32, is not intended to limit the scope of the invention. The scope of the invention is as broad as claimed herein. The illustrations are merely representative of certain, presently preferred embodiments of the invention. Those presently preferred embodiments of the invention will be best understood by reference to the drawings, wherein like parts are designated by like numerals throughout.

Those of ordinary skill in the art will, of course, appreciate that various modifications to the details of the Figures may easily be made without departing from the essential characteristics of the invention. Thus, the following description of the Figures is intended only by way of example, and simply illustrates certain presently preferred embodiments consistent with the invention as claimed.

Referring to FIG. 1, an apparatus 10 may include a legacy photonic source 12 providing a photonic signal 14 to a receiver 18. In certain environments, the photonic source 12 and the receiver 18 are incompatible with one another. In other embodiments, the photonic source 12 and the receiver 18 may be “incompatible” with the intervening network 16 or carrier medium 16 connecting them.

For example, the possible bandwidth resolution that the carrier medium 16 may support is typically much finer than the bandwidth resolution or channel divisions that the spectrum of the legacy photonic source 12 and the receiver 18 may support. Moreover, the photonic receiver 18 may be a newer, more modern, narrowband receiver 18, whereas the legacy photonic source 12 may be a conventional broadband source.

By broadband is not meant the actual bandwidth useful for subdivision, so much as the bandwidth consumed by each channel. Thus, the spreading of spectrum due to the inaccuracies, poor control, mode hopping, frequency hopping, deviation from the mean frequency, drift of signal and the like may be sources of the broadband or spectrum-spreading nature of the legacy photonic source 12.

Some of the causes of the poor performance or the broadness of the bandwidth in each channel of a photonic source 12 may be the result of a broad spectrum output from a photonic source, such as a laser. Meanwhile, poor frequency control or the cost of expansion or replacement of a large installed base of such devices may contribute to the persistence of poor quality in legacy photonic sources 12.

Higher quality sources may typically be very large, expensive, or both. In situations where “real estate” for switching systems, telecommunications stations and the like becomes a premium, product size may drive installed cost of equipment. High quality typically means narrowness of the required bandwidth for a signal having integrity over the entire process of transmission and receipt. Notwithstanding dispersion that may occur within a transmission medium 16, the principal driver limiting the “quality” of a photonic signal 14 is the scattered or unreliable nature of the spectrum at which the legacy photonic source 12 emits a signal 14.

One of the principal results of legacy photonic sources 12 having poor quality is the compounding of problems that will occur due to interactions of imperfections during the course of transmission of the signal 14 through the carrier medium 16 and the related equipment 12, 18. Due to low quality of equipment 12, 18, only comparatively short transmission of distances are available with a suitable degree of integrity of the signal 14. Lack of integrity may be reflected in degradation of signal amplitude, dispersion of signal amplitude, dispersion of signal frequency, modification of pulse shapes, and the like, ultimately resulting in corruption of the modulated data carried thereon.

Thus, one of the effects resulting from the conventional photonic sources 12 and current technology in photonic receivers 18 is a limited information bandwidth. Thus, channel widths are excessively large. Moreover, channel spacing, driven by channel widths and dead bands required for reliability, become comparatively large, consuming more of the available wavelength or frequency spectrum than warranted.

Ultimately, a limited number of signals may be carried. In terms of customers, a limited number of users, customers, destinations, messages, and the like may be served over a particular set of wavelengths in a given system. Thus, greater wavelength bandwidth is required with less informational bandwidth transmitted. Fewer customers can be served, or each can send less information than would be the case if greater integrity of signals, narrower transmission bandwidths, and so forth, could be made available.

The need by legacy photonic sources 12 communicating with photonic receivers 18 is satisfied by a data stabilizer 20. The photonic data stabilizer 20 accepts an input signal 14 over a line 15, stabilizes the signal 14, and provides an output 21 into the carrier medium 16. The photonic data stabilizer 20 provides a stabilized frequency.

In certain embodiments, the data stabilizer 20 may provide a collapsed bandwidth for the signal 21 as compared with the signal 14. Bandwidth collapse means that less actual range of wavelengths will be required in order to transmit the same amount of information modulated thereon. This control may be a result of better frequency control, better phase control, reduced drift, repositioning (wavelength shifting) of signals, information transfer, or a combination thereof.

Some ways that the data stabilizer 20 may accomplish these results include better control of the source 12 by the date stabilizer 20, remote control or seeding of the photonic source 12 by the date stabilizer 20, even without cooperation of the source 12, and such mechanisms to assure the wavelength stability from the source 12. By non-cooperating is meant that the source 12 need not be manufactured or controlled by the party controlling the data stabilizer 20. However, the photonic source 12, in certain embodiments, should not have any isolator preventing sending the seed signal or the like to the photonic source 12.

In other embodiments, the data stabilizer 20 may rely on non-linear gain media as a mechanism to transfer information, shift wavelength, and the like. Thus, increased effective informational bandwidth, by reduced informational signal bandwidth (consumed range of wavelength per channel), and decreased drift, as well as selection or re-selection of wavelengths may be effected by the data stabilizer 20.

In certain embodiments, the foregoing benefits may be achieved by a data stabilizer 20 acting strictly in an optical domain, and not retreating to electronic modulation. In other embodiments, hybrid systems may be embodied in a data stabilizer 20 providing certain computerized control elements, as a matter of convenience, to achieve this reduction of consumed available wavelength bandwidth in the carrier medium 16.

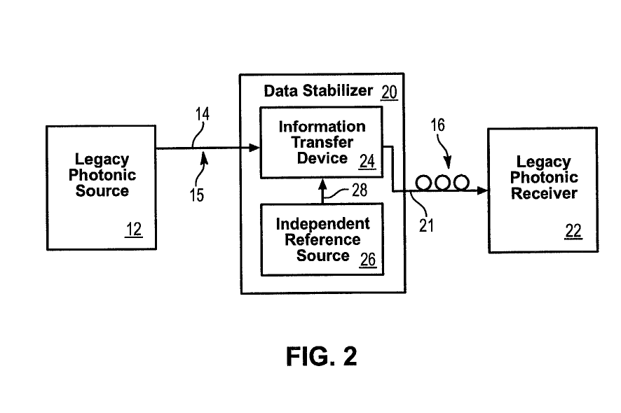

Referring to FIG. 2, one embodiment of an apparatus 10 in accordance with the invention may rely on a data stabilizer 20 between a legacy photonic source 12 and a legacy photonic receiver 22 as illustrated. In the illustrated embodiment, an information transfer device 24 may receive the signal 14 from the legacy photonic source 12. Accordingly, the information transfer device 24 provides a stabilized photonic output 21 to the carrier medium 16 by virtue of transferring the information in the signal 14 to a different wavelength from that originally transmitted by the legacy photonic source 12.

The information transfer device 24 relies on an independent reference source 26. The independent reference source 26 is independent from the photonic source 12, but provides the wavelength that will ultimately be the signal carrier in the signal 21. The reference source 26 provides a signal 28 to the information transfer device 24.

The information transfer device 24 may operate in accordance with several principles of physics. For example, cross-gain modulation, cross-phase modulation, four-wave mixing, and similar phenomena may operate in the information transfer device 24 in order to embed the modulated information from the signal 14 onto the wavelength of the independent reference source 26, producing the output 21.

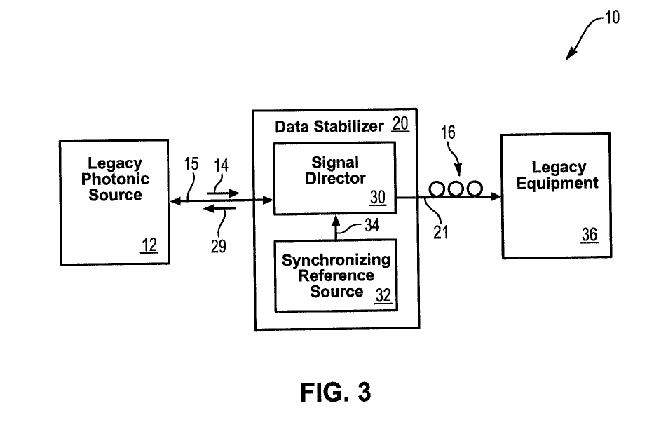

Referring to FIG. 3, an alternative embodiment of an apparatus 10 relies on a data stabilizer 20 providing a seed signal 29 to the photonic source 12. The effect of the seed reference signal 20 on the legacy photonic source 12 is a control of selected characteristics of the output signal 14. Some of the types of controls or effects achieved may include reduction of the energy in undesired modes, or wavelengths resulting, in the photonic source 12.

For example, the photonic source 12 may have a multiplicity of potential modes and wavelengths, with some arbitrary or even undesirable distribution of energy thereamong. The seed reference 29 has the effect of predisposing the photonic source 12 to selected modes and wavelengths. Accordingly, the signal 14 will follow the wavelength bandwidth of the synchronizing reference source 32.

Similarly, the independent reference source 26 and the synchronizing reference source 32 may be selected to reflect a particular state of the art in bandwidth consumption, rather than having to follow that provided by the legacy photonic source 12. As technology advances, the reference sources 26, 32 may be upgraded, without replacing the legacy photonic source 12 with the massive installed base of equipment implicated.

The signal director 30 receives a synchronizing signal 34 from the synchronizing reference source 32. The signal director 30 thereby provides feedback in the signal 29 to the legacy photonic source 12 from the synchronizing reference source 32. Another function of the signal director 30 is to transfer the information from the signal 14, to the output 21 in accordance with the improved bandwidth and wavelength characteristics “inherited” from the synchronizing reference source 32.

Some devices that may serve as signal directors 30, depending on the configuration of the apparatus 10, and the range of wavelengths of interest, may be beam splitters, polarizing beam splitters, circulators, other devices from the class of Faraday rotators, and the like.

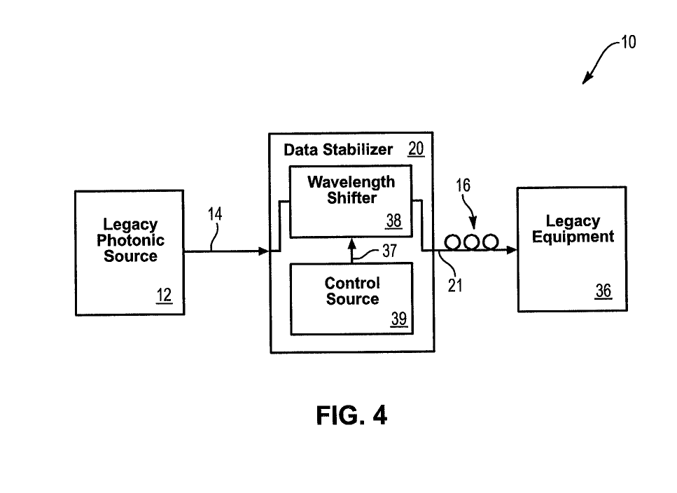

Referring to FIG. 4, an apparatus 10 illustrates another aspect of data stabilization in a data stabilizer 20. In this embodiment, a signal 37 may control a wavelength shifter 38. In general, a wavelength shifter 38 shifts a wavelength of the signal 14 from the legacy photonic source 12 to a desired value. The desired value of the wavelength at the output signal 21 is controlled by the control sources 39. A wavelength shifter 38 may move the wavelength of the signal 21 away from the wavelength of the signal 14.

Wavelength shifters 38 of interest may include single sideband (SSB) wavelength shifters, or mechanisms from the devices of FIGS. 1-3. Moreover, the control source 39 may be selected from certain of the control mechanisms of the devices of FIGS. 1-3, or may be an electronic device hybridizing the data stabilizer 20 into an electro-optical device, rather than a strictly optical device 20. Likewise, other embodiments of the data stabilizer 20 may be fully optical, relying on fully photonic control sources 39, fully photonic control signals 37, and fully photonic wavelength-shifting mechanisms 38.

Notwithstanding the particular embodiments of FIGS. 1-4, certain embodiments may rely on one or more physical phenomena in combination. Thus, a combination of an information transfer device 24, a signal director 30, a wavelength shifter, 38 or the like, in any suitable arrangement, may produce a tailored result in an output signal 21 from a data stabilizer 20. By combining two or more of the effects of the devices 24, 30, 38, a signal 21 may be tailored to service more legacy equipment 36, more individual devices, or to better serve such equipment by careful and closely controlled tailoring of transmitted wavelengths in the signal.

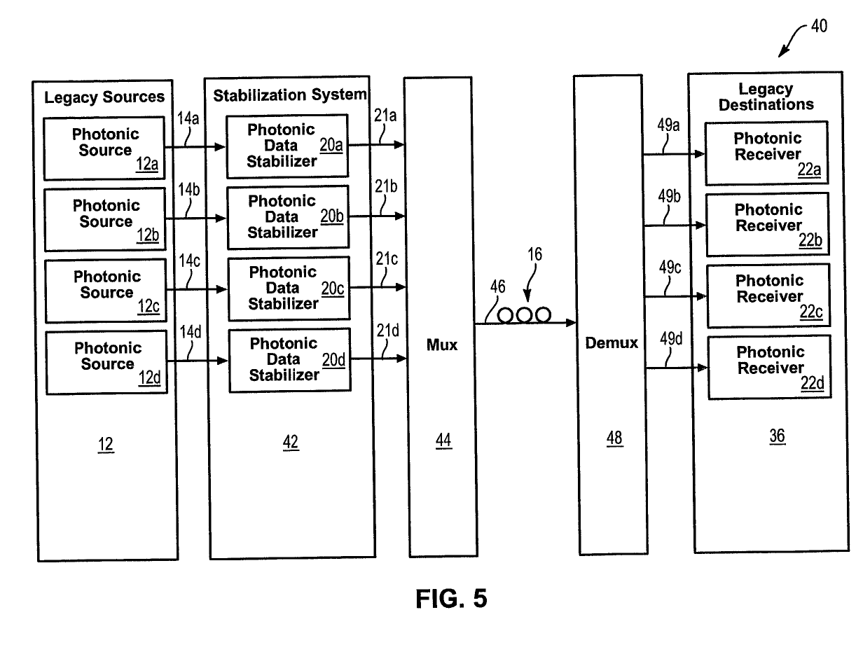

Referring to FIG. 5, incompatible equipment 12, 18, 22, 36, may not be the only, or the ultimate difficulty. In this embodiment, an apparatus 40 may provide a stabilized multiplexing system 40 to accommodate not only hardware incompatibilities, but also data rate incompatibilities. Disparate data rates may be very common even in modem equipment.

Moreover, disparate date rates between legacy equipment and more recent improvements in equipment may be ubiquitous. The illustrated device 40 may accommodate either one or both of these problems.

In the illustrated embodiment, various legacy sources 12 (trailing alphabetical characters on reference numerals simply indicate specific instances of the device designated) may be grouped together or simply provide their signals 14 from various different locations signaling pass to a stabilization system 42 including several photonic data stabilizers 20 for receiving the signals 14.

The outputs 21 from the photonic data stabilizers 20 feed into a multiplexer 44. The multiplexer 44 may be any suitable multiplexer, including a time-division multiplexer, or an optical wave-division multiplexer. Because of the narrowbandedness of each of the photonic data stabilizers 20, each of the output signals 21 is sufficiently narrow in its spectral consumption of bandwidth and sufficiently separated in the spectrum from each of the others 21a, 21b, 21c, 21d, that the multiplexer 44 can multiplex all of the inputs 21 received to form the multiplexed output signal 46. Otherwise, by conventional standards, the signals 14a, 14b, 14c, 14d, may have been incompatible because of poor wavelength control, broad spectral distribution of energy, incompatible data rates, wavelength hopping, wavelength drift, and the like in the legacy sources 12.

The carrier medium 16 delivers the multiplexed signal 46 to a demultiplexer 48 corresponding to the multiplexer 44. The demultiplexer 48 subdivides the signal 46 into the demultiplexed signals 49. Each of the demultiplexed signals 49 corresponds to one of the signals 14 from the photonic sources 12. Accordingly, each of the signals 49a, 49b, 49c, 49d, is input into one of the photonic receivers 22a, 22b, 22c, 22d, respectively, at the legacy destinations 36.

In certain embodiments, the legacy destinations 36 need not be of a legacy type. That is, the photonic receivers 22 may be completely incompatible with the original data rates and wavelengths of the signals 14 for any of several reasons. The destinations 36 may be more modern than the legacy sources 12. In an alternative embodiment, the legacy destinations 36 may be as poor in quality as the legacy sources 12, or worse. That is, the high quality of the narrowband signals 49 may be received fine by conventional photonic receivers 22, since each of the signals 49 may be relied upon to be within the band expected by the respective photonic receiver 22.

The signals 49 need not correspond exactly with the signals 14, but may be reprovisioned, redirected, and the like by means of the multiplexer 44 and demultiplexer 48. In addition, certain embodiments of an apparatus 40 may provide reprovisioning of signals 21, and ultimately signals 49, within the data stabilization system 42. By appropriate shifting of controlled wavelengths at which each of the photonic data stabilizers 20 operates, the outputs 21 may be reprovisioned, dropped, added, and so forth as needed to support the inputs 49 to the photonic receivers 22.

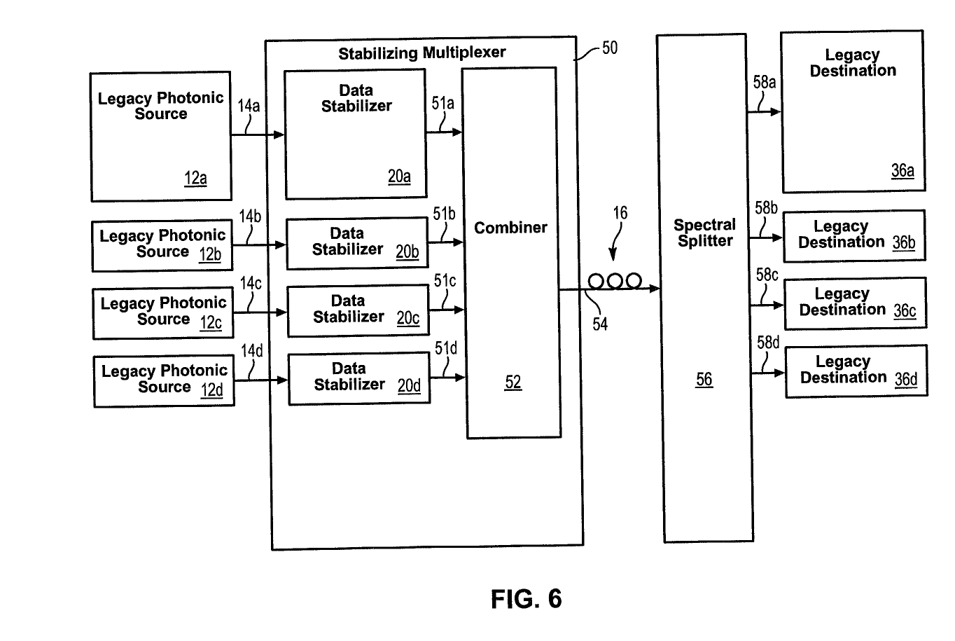

Referring to FIG. 6, a stabilizing multiplexer 50 may benefit from the data stabilizers 20 in order to provide signals 51 stabilized in preparation for being combined by a combiner 52 into a combined, stabilized, photonic output signal 54. In the illustrated embodiment, the legacy photonic sources 12 may be consolidated, or completely independent from one another, each providing its respective output signal 14 to a corresponding data stabilizer 20.

The stabilizing multiplexer 50 takes photonic signals 51 through a combiner 52, resulting in a fully multiplexed signal 54 distributed through a carrier medium 16 toward destinations 36. In the illustrated embodiment, a multiplexer 44 formed by the combination of data stabilizers 20 and a combiner 52 need not require a demultiplexer 48. Instead, a spectral splitter 56 may be sufficient to subdivide the multiplexed signal 54 into the individualized outputs 58 corresponding to each of the respective destinations 36.

Some attention to the strength of signals 54 resulting from the stabilizing multiplexer 50 may be a consideration in the embodiment selected for a particular application. For example, circulators may be somewhat more efficient in relaying signals than are certain classical photonic components for combining and splitting.

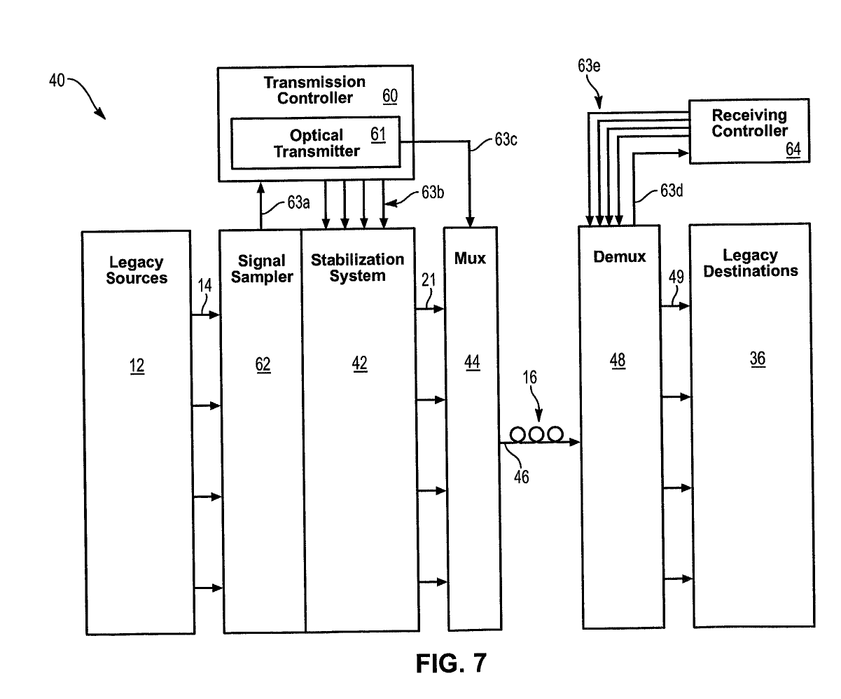

Referring to FIG. 7, the stabilization system 42 may be rendered more dynamic and active for purposes of configuration, provisioning, and other control functions by adding a transmission controller 60. A transmission controller 60, provided with an optical transmitter 61, may receive from a signal sampler associated with a stabilization system 42, an input signal 36a. Accordingly, the controller 60 may provide feedback control signals 63b to the stabilization system 42.

Ultimately, the optical transmitter 61 forwards control signals 63c to the multiplexer 44. The multiplexed signal 46 passed between the multiplexer 44 and demultiplexer 48 over the intervening carrier medium 16 may be further manipulated as a result of a receiving controller 64 associated with a demultiplexer 48. That is, the feed forward signal 63c from the transmission controller 60 passes, as a part of the multiplexed signal 46 to become the output 63dfrom the demultiplexer 48, directed to the receiving controller 44. In accordance with the information contained in the signals 63c, 63d, the receiving controller 64 provides control signals 63e to the demultiplexer 48.

In accordance with the embodiment illustrated, the receiving controller 64, in cooperation with the transmission controller 60, may operate to implement dynamic provisioning of signals between the source 12 and the destination 36. Moreover, additional stability may be provided by virtue of the control information in the signal 63c, 63d passing to the multiplexer 44 and demultiplexer 48. That is, the additional control asserted by the transmission controller 60 and receiving controller 64 may tune, shift, tweak, and otherwise assert control over the multiplexer 44 and demultiplexer 48. Techniques such as tracking by the demultiplexer 48 of the particular wavelengths provided by the stabilization system 42 in the signals 21 may permit or facilitate more closely and precisely spaced signal wavelength.

Operating the stabilization system 42 and the multiplexing system 44 and demultiplexing system 48 in an open loop configuration would leave the stabilization system 42, multiplexer 44 and demultiplexer 48 each to their own inherent performance characteristics. Each is subject to the vagaries of time, temperature, and the like. By providing the feed forward of the signals 63c, 63d, each may know the status of the other. Each may adjust accordingly in order to require less deadband, and provide narrower total consumed bandwidth for each respective signal 21, 49. As a practical matter, the demultiplexer 48 tracks or may track the multiplexer 44, the stabilization system 42, or both tracking simply establishes the data for all three to use to cooperate.

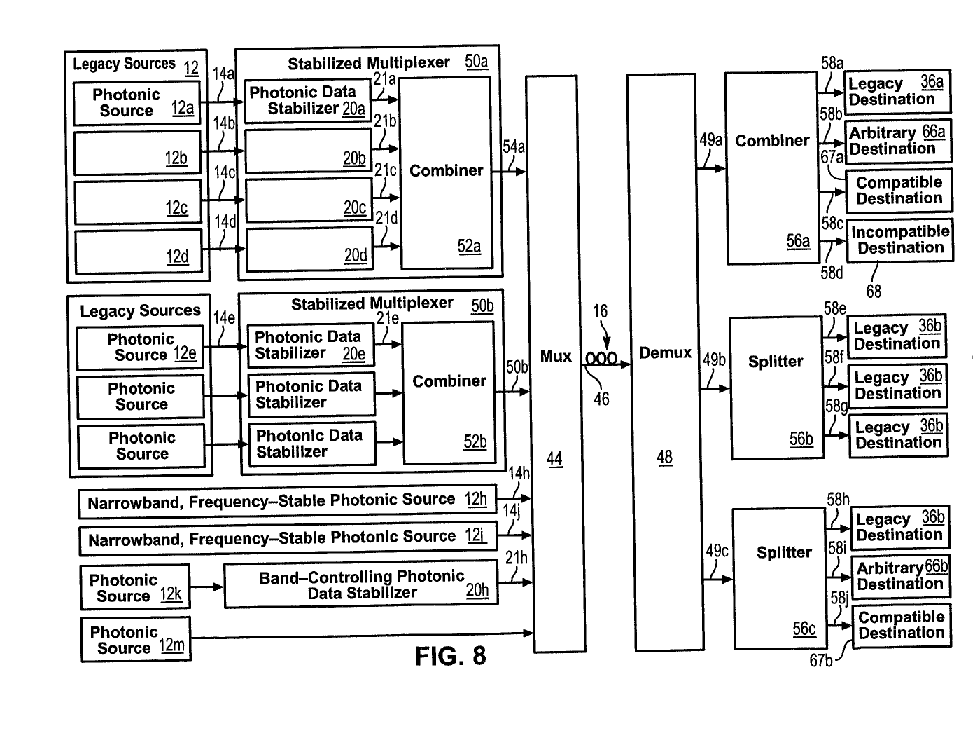

Referring to FIG. 8, a variety of legacy sources 12 may be grouped by stabilized multiplexers 50a, 50b, providing stabilized, multiplexed signals, 54a, 54b, into a conventional multiplexer 44. Meanwhile, the conventional multiplexer 44 may also multiplex signals 14h, 14j, from other narrowband, frequency-stabilized photonic sources 12h, 12j. Independent band-controlling photonic data stabilizers 20h, may also provide signals 21h into the conventional multiplexer 44.

In addition, bandwidth in the multiplexer 44 may be allocated in such a way that the stabilized multiplexed signals 54a, 54b or other frequency-stabilized signals 14h, 14j, 21h, consume only a comparatively reduced portion of bandwidth, while conventional signals 14 from other unregulated and unaffected photonic sources 12 are also fed into the multiplexer 44.

In general, the demultiplexer 48 may provide outputs 49a, 49b, 49c, to splitters 56a, 56b, 56c. In turn, the splitters 56 may act to further subdivide the signals 49 into output signals 58. Each of the signals 58 services a particular destination 36, 66, 67, 68, as appropriate. For example, legacy destinations 36 may be serviced by the signals 58. However, any arbitrary destination 66 may be serviced, whether of legacy quality of improved quality, or of a quality specifically designed for operation with the photonic data stabilizers 20. Thus, a compatible destination 67a may be one specifically designed to operate with photonic data stabilizers 20. Meanwhile, however, formerly incompatible destinations 68, incompatible with either legacy photonic sources 12, or previously wasting available bandwidth in the carrier medium 16, may be rendered compatible by virtue of operation of the photonic data stabilizers 20.

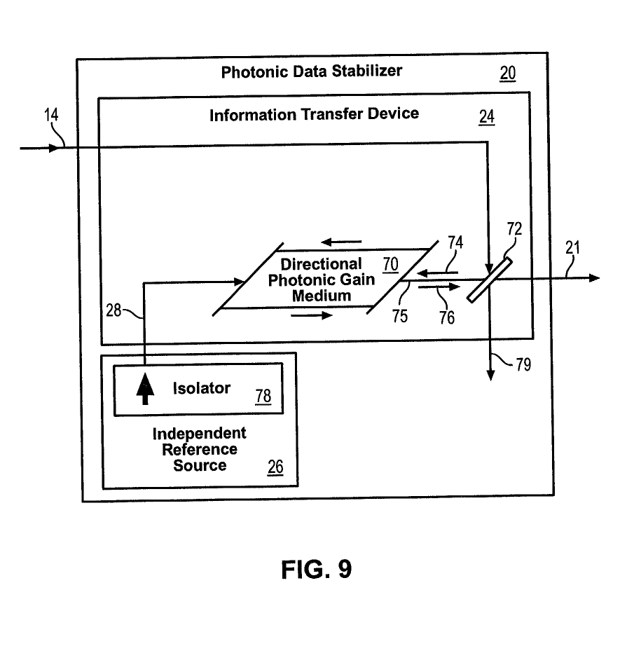

Referring to FIG. 9, a data stabilizer 20 may be constructed around a bi-directional photonic gain medium 70 as a central element of an information transfer device 24. In the illustrated embodiment, a legacy photonic output 14 from a legacy photonic source 12 may serve as an input 14 into the information transfer device 24. The signal 14 includes modulated information imposed thereon, and directed toward a director 72. In one embodiment, the director 72 may be a beam splitter 72, a circulator 72, or the like.

In operation, a signal 74 is split from the signal 14 by the director 72 and fed into the directional photonic gain medium 70. The medium 70 provides an output signal 76 directed to the director 72, along the output path 75. Ultimately, the signal 76 may be split, providing a portion of the energy thereof, and all of the data thereof, as an output signal 21 from the information device 24 and photonic data stabilizer 20. In the illustrated embodiment, an independent reference source 26 provides a signal 28 to the directional photonic gain medium 70 in a direction opposite the signal 74, and coincident with the signal 76. An isolator 78 associated with the reference source 26 suppresses the influence of any residual energy from the signal 74 that may pass to the reference source 26 from the directional photonic gain medium 70. The wasted energy 79 from the director 72 may be absorbed or discharged to a dump.

Similarly, energy divided from the output signal 76 by the director 72, may be sent to waste by an appropriate, guided path. The medium 70 may modulate the signal 28 from the reference source 26 in accordance with the data in the signals 14, 74. Coupling may be by cross-gain modulation in such a configuration.

By contrast, if the director 32 is a photonic transistor, coupling may be by cross-phase modulation at the director 72. Accordingly, the information transfer device effects transfer of information, modulated onto the input signal 14, into the signal 28 of the independent reference source 26 into the output 76 of the photonic gain medium 70. Ultimately, although inverted, the data is embodied by either mechanism in the output 21 of the photonic data stabilizer 20.

The reference source 26 may be selected to be substantially more stable in any or all of the characteristic features described hereinabove, with respect to the input signal 14, thus providing a stabilized signal 21 having narrower bandwidth requirements for transmission. Moreover, by proper selection of the wavelength performance characteristics on the reference source 26, the signal 21 may be wavelength shifted from the input signal 14, in addition to other stabilizing alterations.

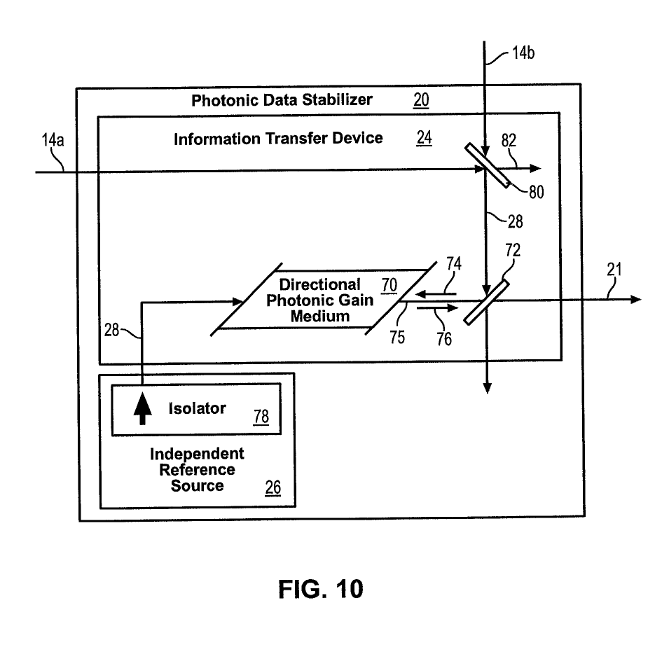

Referring to FIG. 10, one embodiment of a photonic data stabilizer 20 may accept multiple inputs 14a, 14b. Accordingly, an additional director 80 may be positioned to direct each of the signals 14a, 14b (or, perhaps more properly, a portion of each)toward the director 72. The signal 81 embodies the information of both signals 14a, 14b. The director 72 directs the signal 81 toward the directional photonic gain medium 70, although a portion thereof may go to waste 79. As discussed above, the path 75 carries both the input signal 74 into the photonic gain medium 70, as well as the amplified return signal 76 therefrom.

Meanwhile, the independent reference source 26 provides an output signal 28 through an isolator 78 to the photonic gain medium 70. This configuration facilitates transfer of the information in the signals 14a, 14b, onto the signal 76.

Similar to the director 72, the director 80 may send out as waste energy 82 portions of the signals 14a, 14b impinging thereon. Meanwhile, the director 80 operates in a fashion similar to the director 72 regarding the redirection of the signals 14a, 14b, into the signal 81.

In certain embodiments, the director 80 may act as a threshold-level gating device 80 depending upon the total intensity in the signal 81 resulting from both of the signals 14a, 14b. That is, if only one signal 14a or 14b is present, then the intensity of the signal 81 may be substantially reduced. According to the amount of that reduction, the signal 74 may or may not be sufficiently large to effect the necessary intensity in the signal 76 to provide the output 21.

In yet another alternative embodiment, the director 80 may be a photonic transistor, gating the signals 14a, 14b, with respect to one another, by virtue of interference. In certain embodiments, depending on the relative intensities of the signals 14a, 14b, the director 80 may serve in combination with one or the other of the input signals 14a, 14b. The director 80 may stabilize the other signal 14b, 14a. The physical phenomenon is an amplitude adjustment of the total input power of the signal 81 being provided to the photonic gain medium 70. Such intensity will affect the depth of modulation of the output signal 21.

Even in a circumstance where the signals 14a, 14b are modulated differently and are characterized by different carrier wavelengths, the director 80 may still operate to deliver both to the director 72, and ultimately to the photonic gain medium 70. The resultant output 21 provides two, separately modulated signals, superimposed, on the same carrier frequency, characterizing the signal 28 from the reference source 26. The carrier wavelength of the signal 28, the output 76, and the output 21 from the photonic data stabilizer 20, are all characterized by the same wavelengths. Thus, the information transfer device 24, operates to transfer information from multiplexed wavelengths corresponding to the signals 14a, 14b onto a single carrier wavelength corresponding to the output signals 76, 21. Multiple functionality may be provided from the photonic data stabilizer 20 including operation as an AND function for purposes of Boolean logic by the director 80.

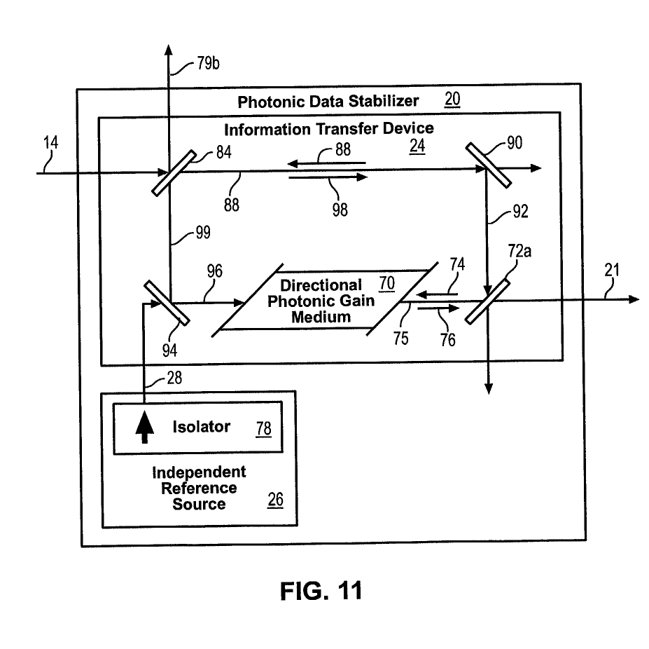

Referring to FIG. 11, the directional photonic gain medium 70 provides preferential gain in favor of the strongest signal passing there through. Accordingly, the independent reference source 26 may provide a larger amplitude signal 28, dominating the gain in the directional photonic gain medium 70. Also, each of the independent reference sources 26, when arranged to provide a signal 28 having the same frequency as the input signal 14, facilitates the directional photonic gain medium 70 providing an output signal 76 phase locked to the independent reference source 26. Thus, the information modulated on the signal 14 is carried into the output signal 21, but is phase locked against drift by the independent reference source 26.

The information transfer device 24 of the illustrated embodiment is a ring version of the previously described devices 24. In general, the photonic data stabilizer 20 may receive a signal 14, output a signal 21, based on modulating the information from the signal 14 onto a signal 28 provided by the independent reference source 26. In this case, the input signal 14 passes through a splitter 84 along a path 86, advancing a signal 88, past a mirror 90 to a director 72a. In general, the signal 74 embodies the information of the signal 14, passed into the directional photonic gain medium 70.

The directional photonic gain medium 70 has a preferential gain in favor of the signals 96, 76 over the signal 74, due to the amplitude intensity provided by the independent reference source 26 in the signal 28. Thus, the portion of the signal 14 reflected from the director 72a into the directional photonic gain medium 70 as the signal 74 is amplified by the directional photonic gain medium 70 and passed on to the splitter 94. A portion of the amplified signal 74 will be wasted, and a portion will be reflected toward the splitter 84.

At each splitter 84, 94, as well as the director 72a, a portion of the waste 79 passes through. The reflected portion of the signal 74, eventually passes from the splitter 84 to the mirror 90, to the director 72a, and back into the directional photonic gain medium 70.

Meanwhile, the independent reference source 26 provides a signal 28 through the splitter 74, resulting in a signal 96, amplified by the directional photonic gain medium 70. Ultimately, the signal 28, with the information of the signal 14, 74 modulated thereon, results in a signal 76 as an output of the photonic gain medium 70. The signal 76, although split between the paths 92 toward the mirror 90 and the output 21, provides the phase-locked, information-transferred signal 21. In this embodiment, signals are traversing in both directions of the paths 86, 92, 96, 99.

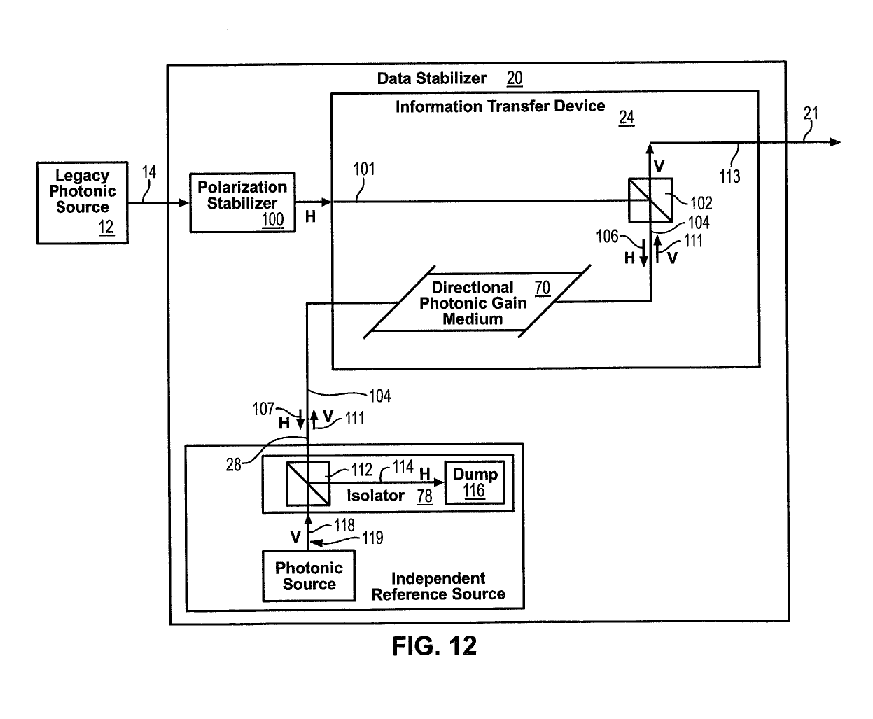

Referring to FIG. 12, one embodiment of a photonic data stabilizer 20 may include a polarization stabilizer 100 for receiving the signal 14 from a legacy photonic source 12. This particular embodiment of a photonic data stabilizer 20 is of the type embodying an information transfer device 24. The signal 101 output by the polarization stabilizer 100 impinges on a polarization beam splitter 102.

Due to the polarization stabilizer 100, the orientation of each signal 101 and output signal 21 is significant. In the illustrated embodiment, the signal 101 is horizontally oriented, while the signal 21 is vertically oriented. These directions are simply with respect to one another, and need not be referenced to any actual horizontal or vertical direction. That is, each is for identification purposes only to identify the relative polarization thereof.

Along the path 104, the horizontal component 106, corresponding to the signal 101, is redirected by the polarization beam splitter 102. The signal 106 passes on to the directional photonic gain medium 70. The output 107 then passes toward the independent reference source 26, but is intercepted by the isolator 78. A polarization beam splitter 112 redirects the signal 107 into the signal 114 and a dump 116.

The photonic source 120 provides a signal 119 along a path 118 and through the polarization beam splitter 112. The signal 119 passes to the path 110 toward the directional photonic gain medium 70 as the vertically oriented signal 108. The amplified signal 111 results, passing through the polarization beam splitter 102 as the vertical signal 113. The signal 113 ultimately results in the output signal 21, oriented with the polarization orientation of the signal 118 from the photonic source 120.

Meanwhile, the directional photonic gain medium 70 has embodied the informational content from the signal 14 on the signal 111, and ultimately the output 21. The polarization beam splitter 102 provides the preferential direction to support the information transfer device 24.

One advantage of an information transfer device 24 operating on polarization principles is that no need exists to lose a major portion of the amplitude of a particular signal, so long as the orientations of beam splitters and incoming beams are consistent with one another. Thus, the photonic data stabilizer 20 of the illustrated embodiment provides a particularly efficient mechanism for imposition of the information from the signal 14 from a legacy photonic source 12 onto the output 118 of a photonic reference source 126. Significantly, the cross-gain modulation occurring in the directional photonic gain medium 70 occurs between two signals of different polarization orientations.

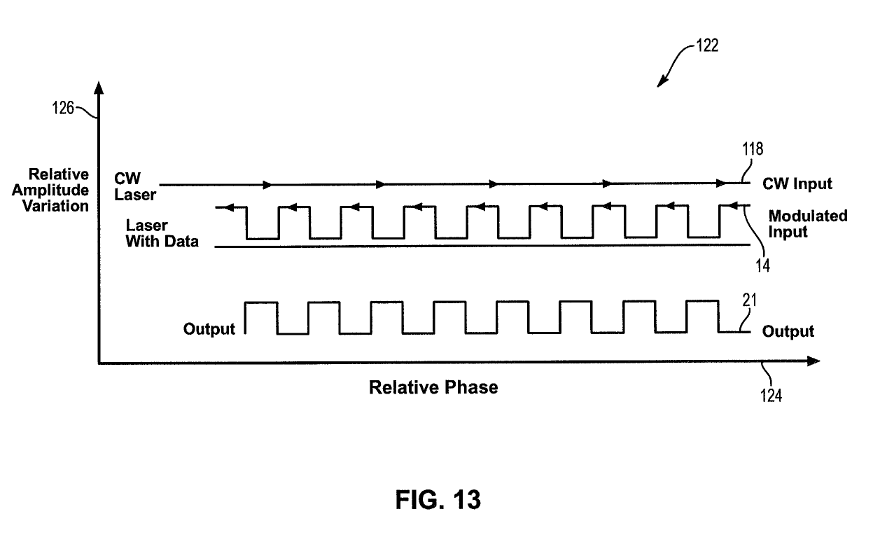

Referring to FIG. 13, a signal comparison 122 illustrates the relative phase relationships between various signals 14, 21, 118. As illustrated, the relative phase axis 124 is just a posed against the relative amplitude variation 126 for each of the signals 14, 21, 118. The relative signal directions are illustrated by arrows. Notably, the signal 118 is a substantially continuous wave input 118. Meanwhile, the modulated input 114 has a phase sense opposite to that of the output signal 21.

The modulation referred to with respect to the signal 14 is the information modulation, not the carrier wavelength. Similarly, the opposite sense of the input 14 with respect to the output 21 also refers to data modulation, and not the intrinsic carrier frequencies thereof.

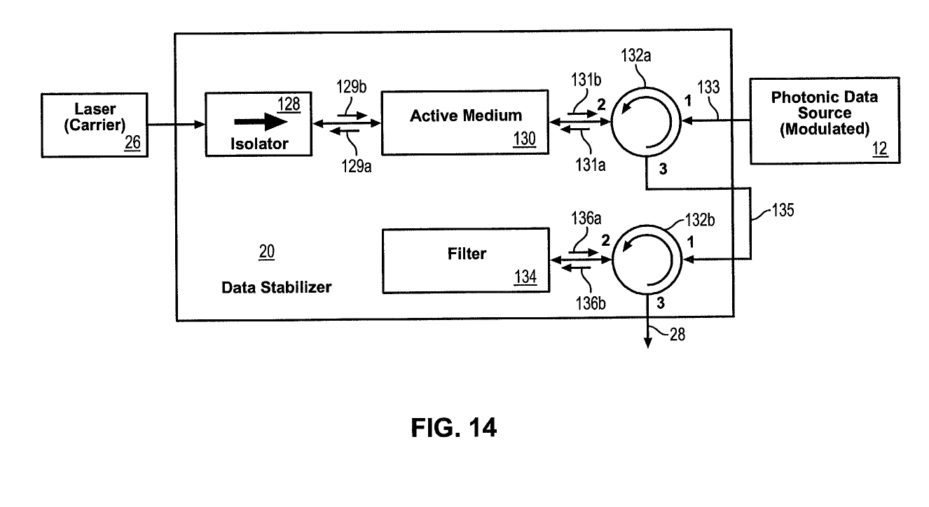

Referring to FIG. 14, a photonic data stabilizer may be embodied in a different set of mechanisms. In the illustrated embodiment, a photonic data source 12 may provide a modulated signal 133 to a circulator 132a. The circulatory 132a, in turn, provides a signal 131a to an active medium 130. In general, the active medium 130 operates as a cross-gain modulator for transferring the information from the signal 131a into the signal 129b arriving from the laser source 26 providing the carrier frequency.

In the illustrated embodiment, a certain portion of the signal 131a may be amplified by the active medium 130 and passed as the signal 129a toward an isolator 128. However, the isolator 128 protects the laser 126 against being seeded by the signal 129a. Thus, the signal 129b corresponds to the output of the laser 26, and is the source of the carrier frequency (wavelength) on which the information from the signal 131a will be imposed.

The signal 131b, now modulated with the data from the signal 133, yet having the carrier frequency of the signal 129b passes to the circulator 132a, acting as a director 132a directing the signal 131b out as a signal 135. The signal 135 passes to a circulator 132b or other director 132b to a filter 134. The filter 134 receives the signal 136a (effectively the signal 135) as an input. The filter 134 is responsible for filtering the desired frequency to be reflected back as the signal 136b, while passing the undesired wavelengths of the signal 136a.

The circulator 132b, once again acts as a director with respect to the signal 136b, providing the output 21 therefrom. In this manner, the signal 21 has the data originally embodied in the signal 133 from the photonic data source. However, the wavelength corresponding thereto is the wavelength of the carrier produced by the laser 26 and the signal 129b.

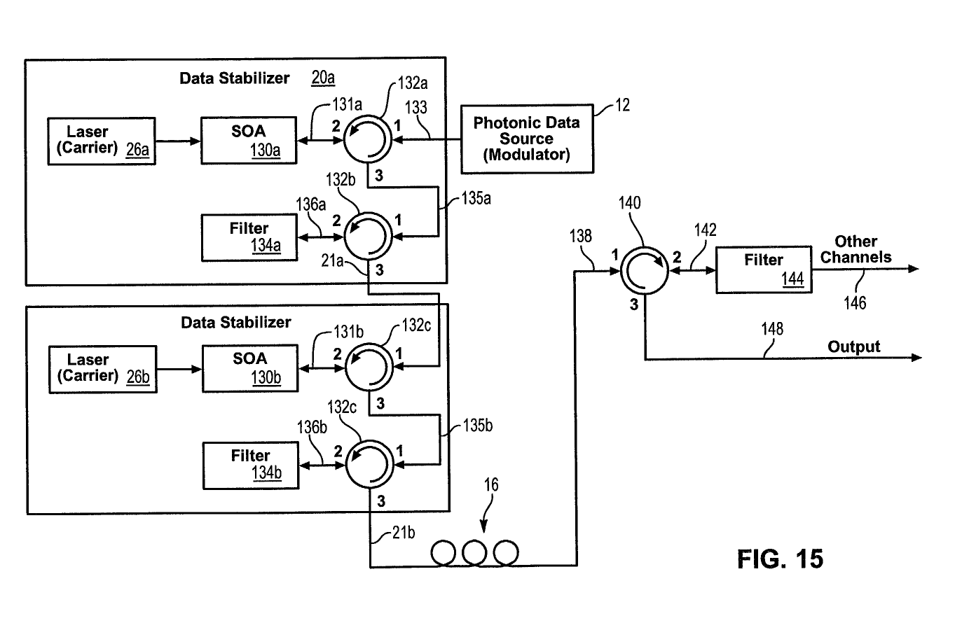

Referring to FIG. 15, multiple data stabilizers 20a may be connected in series in order to provide certain benefits. In the illustrated embodiment, the data stabilizer 20a provides an output signal 21a to the data stabilizer 20b. One effect of the data stabilizer 20a is to provide a narrower bandwidth about the carrier wavelength of the referenced laser 26a. This is embodied in the signal 135a, output from the silicon optical amplifier (SOA) 130a through the circulator 132a. The signal 21a, is inverted from the sense of the modulation of the photonic data source 12. The signal 121a is reinverted by the second data stabilizer 20b.

An added benefit is that the noise floor of the spectrally narrowed, modulated data is further reduced. This occurs, provided that the filters 134a, 134b have substantially equal performance parameters. Disparities between the performance parameters of the filters 134a, 134b, may be relied upon to provide even further narrowing of the overall bandwidth surrounding the carrier frequency of the output signal 21b.

The output signal 21b, after passing through the carrier medium 16 over some distance, arrives as an input 138 at the circulator 140. The circulator directs the modulated signal 138 to a filter 144 along the path 142. The filter 144, in turn, passes some portion of the wavelength embodied in the signal 138 out to either waste or other channels along a path 146. Meanwhile, the desired bandwidth of the signal 138 is reflected back from the filter 144 along the path 142 to the circulator 140.

The circulator then passes this signal out as an output 148. In reality, the output 148 may be selected for certain purposes, while the output 146 may be selected for other purposes. For example, the comparatively narrower portion 148 may actually be selected to encompass whatever bandwidth the filter 144 may be designed to reflect.

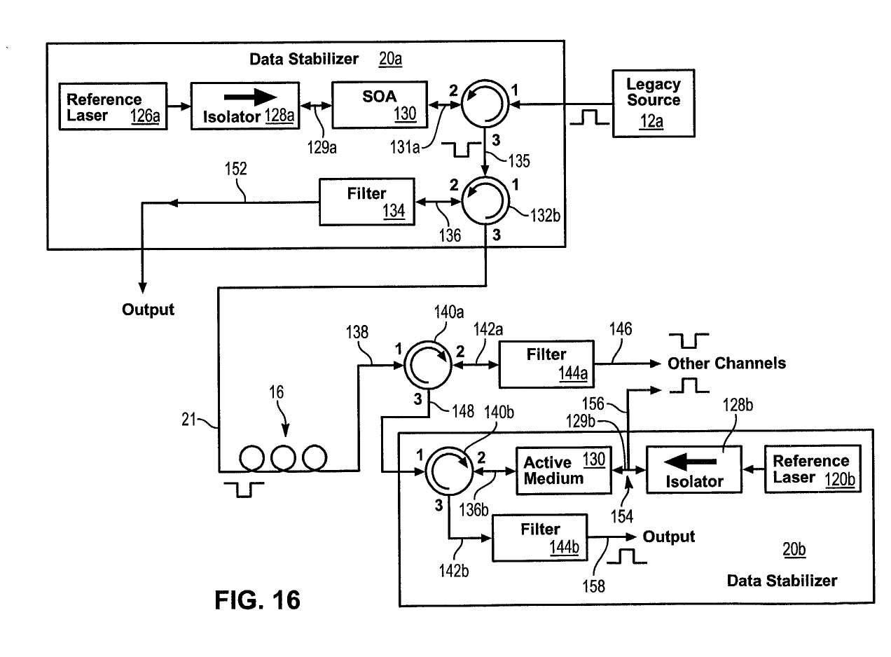

Referring to FIG. 16, inversion of a signal at a transmitting end of a system need not be corrected at the transmitting end of the system. For example, in the illustrated embodiment, a data stabilizer 20a receives a legacy signal 133 from a legacy source 12a. The data stabilizer 20a provides an output 21 to the carrier medium 16. However, the signal 21 remains inverted throughout transmission through the carrier medium 16, arriving as a signal 138, still inverted.

Incidently, the filter 134 may be configured to provide an output signal 152 constituting all of the passed signal from the filter 134. The signal 152 is also inverted, but provides an ability to split a signal 135 into contributing signals 21, 152. Thus, the separation of the signals 21, 152 at the source 20a facilitates additional flexibility in transmission to locations, multiplexing, and the like.

Likewise, with the filtering capacity of the data stabilizer 20a, the narrowbandedness of each of the signals 21, 152 may be selected by proper design of a filter 134. As a practical matter, selection of the specific band that the filter 134 passes, the band that the filter 134 reflects, and the distribution of channels between the signal 21 and the signal 152 may be a matter of design choice.

A signal 138 received over a carrier medium 16 may pass to a circulator 140a, which then provides for channel separation. That is, along the path 142a, or signal 142a, a filter 144a separates out a signal 146 constituting one or more channels. The circulator 140a returns the reflected signal 142a from the filter 144a as an output 148. The signal 142a may be thought of as constituting an input signal from the circulator 140a to the filter 144a, and also a narrower banded signal 142a reflected from the filter 144a to the circulator 140a.

The output 148 from the circulator 140a may be input to a second data stabilizer 20b. Accordingly, the data stabilizer 20b provides selected options. For example, if desired, a separator 154 may be connected to the active medium 130, providing an additional output 156. Meanwhile, the circulator 140b, in combination with the filter 144b, provides a restored output 158. By restored is meant that the inversion of the signal 21 has been restored to the same sense (re-inverted, to become newly uninverted) having the same sense as the original input signal 133 from the legacy source 12a.

Thus, in the embodiment illustrated in FIG. 15, the signal 21b exists as a restored signal, having been restored by the date stabilizer 20b at the sending end. In the embodiment of FIG. 16, the inverted signal 21 is transmitted as an inverted signal 121 through the carrier medium 16 to a receiving end. There the data stabilizer 20b of FIG. 16 performs the reinversion, providing a restored output 158. In selected embodiments, re-inversion may not be required at either the sending end or the receiving end.

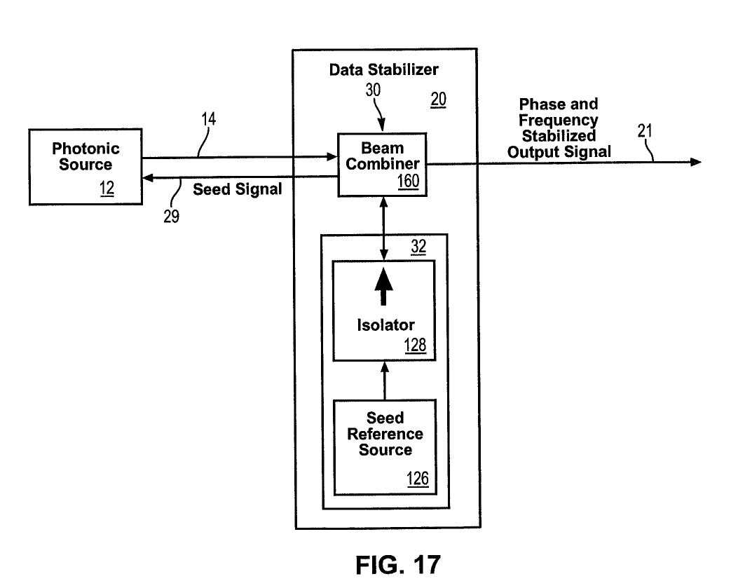

Referring to FIG. 17, a data stabilizer 20 may be configured to provide a seed reference signal 29 back to an originating photonic source 12 providing the original signal 14. Accordingly, the date stabilizer 20 may predispose the photonic source 12 to provide a signal 14 corresponding to that provided by the seed reference source 126. As a practical matter, the geometry, chemistry, and other characteristics of the photonic source 12 may limit the modes in which it can provide controlled wavelengths in the signal 14. Nevertheless, the presence of the seed signal 29 may predispose the photonic source 12 to certain preferential modes beneficial to production of the output signal 21 by the data stabilizer 20.

Applications of the apparatus of FIG. 17 may provide redirection by the combiner 160 in accordance with the apparatus of FIG. 3. The data stabilizer 20 has the effect of reducing the energy embodied in wavelengths corresponding to the signal 14 that are most disparate from the wavelength corresponding to the seed reference source 126. Thus, the data stabilizer 20 tends to “motivate” the photonic source 12 to redistribute energy from the signal 14 into wavelengths that are phase and frequency stabilized relative to the seed reference source 126. Thus, the data stabilizer 20 may effect a narrowing of the bandwidth of the signal 14, while maintaining complete integrity of the information modulated onto the signal 14. Thus, the output signal 21 from the data stabilizer 20 is stabilized in phase and frequency, providing the benefits discussed hereinabove.

In this particular embodiment, the seed reference source 126 provides the output signal 29 to the beam combiner 160. The combiner 160 may be any one of several appropriate types. The seed signal 29 predisposes the photonic source 12, providing an element of control or influence over the output signal 14 from the photonic source. The beam combiner 160, then passes a substantial portion of the signal 14 through as an output 21.

In certain embodiments, the beam combiner 160 may be a beam splitter of 160. For example, amplitude beam splitters, polarization beam splitters, and the like may be relied upon.

Similarly, the beam combiner 160 may be a fiber combiner, a circulator, or the like. Various configurations of devices using Faraday rotators, as do circulators, may provide the functionality required for the beam combiner 160.

The isolator 128 in the photonic synchronizing reference source 32 provides protection against feedback of the signal 14 into the photonic synchronizing reference source 32. In certain embodiments, the beam combiner 160 may not require an isolator 128. For example, if the beam combiner 160 is a circulator, then an isolator 128 in the photonic synchronizing reference source 32 may not be required.

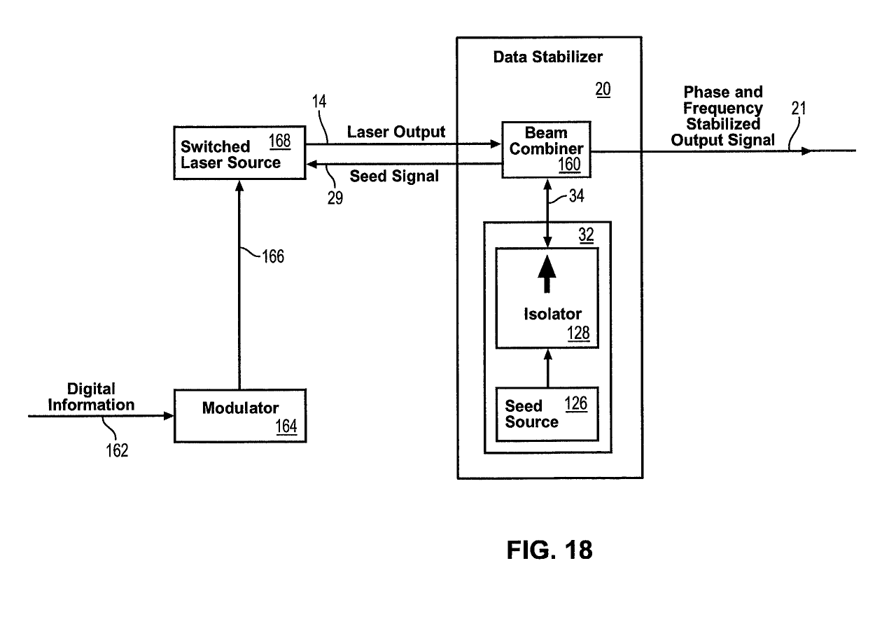

Referring to FIG. 18, a data stabilizer 20 may be connected to stabilize a switched laser source 168. In the illustrated embodiment, digital information 162 provided to a modulator 164 may result in an output 166. The output 166 effectively modulates the information 162 onto the output 14 provided by the switched laser source 168. As with the embodiment of FIG. 17, the laser output 14, provided to the date stabilizer 20, is stabilized by the data stabilizer 20 to provide the phase and frequency stabilized output 21. Meanwhile, the photonic synchronizing reference source 32 providing the seed signal 29, predisposes the switched laser source 168 to the phase and frequency configuration desired for the output 21.

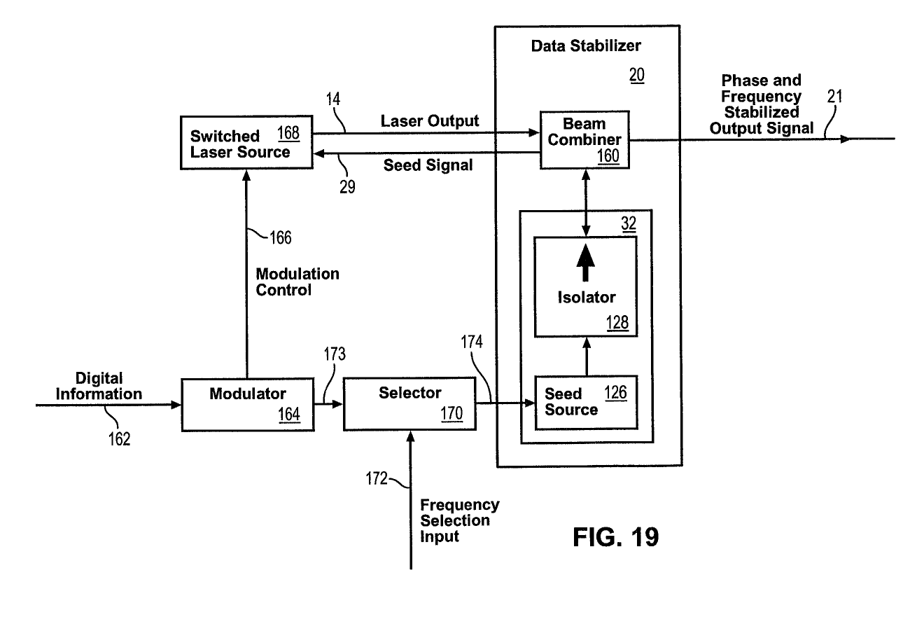

Referring to FIG. 19, the switched laser source 168 may be further improved in performance or operate with additional features. For example, the data stabilizer 20 may be configured to operate with a frequency selector 170. In such a case, an outside frequency selection input 172 may be used to control the frequency of the seed reference source 126. Ultimately this effects the frequency selected in the stabilized output signal 21. Accordingly, the frequency selection input 172 may ultimately control the channel selection for the output signal 21.

In certain embodiments, the frequency selection input 172 may be programmatically controlled. Alternatively the input 172 may be otherwise controlled. In either event, the input 172 may incorporate coding schemes in the data stream carried by the stabilized output signal 21.

In certain embodiments, the synchronization signal 173 may synchronize the frequency selection process of the frequency selector 170 with some aspect or characteristic of the modulator 164. In general, the digital information 162 is the information desired to be modulated onto the signal 21, as a stabilized output signal 21 from the data stabilizer 20. A modulator 164, having modulated the digital information 162 onto the modulation control signal 166, effectively modulates the switched laser source 168. This process effectively embodies the information 162 onto the laser output 14.

Meanwhile, the modulator 164 by providing the optional signal 173 to the selector 170, may synchronize the modulation 164 with the frequency changes imposed by the frequency selection 172. Thus, the selector 170 effectively “switches channels” or otherwise encodes while the modulator 164 provides the information therefor. Accordingly, the stabilized output signal 21 includes the proper information 162 encoded for the proper path, destination, functionality, or the like, as dictated by the frequency selection input 172.

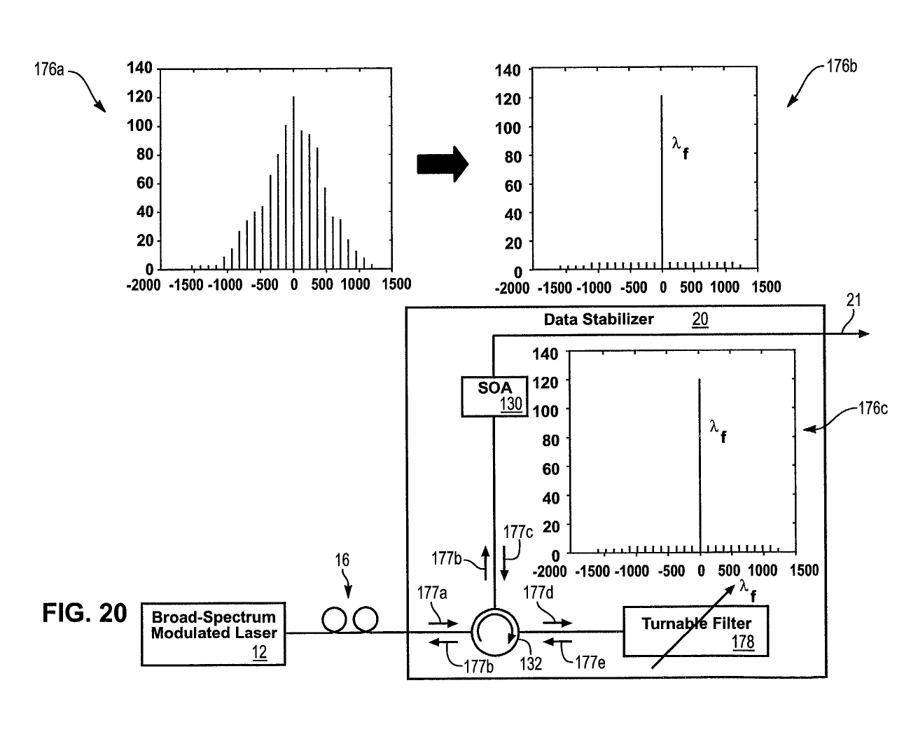

Referring to FIG. 20, a data stabilizer 20 connected to a broad spectrum modulated photonic source 12 is illustrated with graphs representing the spectral distribution of the frequency spectrum (wavelength spectrum) provided by the photonic source 12. The graph 176a represents schematically the spectral distribution of energy in the output 14 from the photonic source 12 in the absence of the seeding capability of the data stabilizer 20. By contrast, the graph 176b illustrates schematically the narrowing of the spectral distribution of energy in the signal 14. The distribution narrows from the broad-spectrum modulated photonic source 12 when relying on the seeding effect of the data stabilizer 20. The result in the stabilized output 21 from the data stabilizer 20 is a signal having a narrowband characteristic of wavelength corresponding to the graph 176c illustrated. The information from the modulation of the photonic source 12 is thus embodied in the signal of the graph 176c as output by the stabilized output signal 21.

The circuitous paths traversed by the signals 177 implement amplification by the silicon optical amplifier 130 or other active media. Tuning by the tunable filter 178 provides narrowing of the signal amplified by the active media 130.

A broad-spectrum modulated photonic source 12 may provide a signal 14 over a transmission medium 16 to a circulator 132 as an input signal 177a. The circulator 132 passes an output 177b to an active medium 130 for amplification. In general, the amplification medium 130 may pass a majority of the energy from the input signal 177b to the output signal 21. However, any portion of the signal 177b that is returned by the active medium 130 to the circulator 132 as a signal 177c, regardless of whether it constitutes modulated signal or noise, is typically accepted by the circulator 132.

Accordingly, the circulator 132 provides an output 177d to a tunable filter 178. The tunable filter 178, reflecting a signal 177e, having narrower spectral bandwidth than the incoming signal 177d, thus provides seeding. Seeding passes the circulator 132 passes back to the broad-spectrum modulated photonic source 12 as the signal 177f. The overall bandwidth of the output signal 21 may be highly influenced by the overall initial bandwidth of the photonic source 12 without feedback (seeding). Also affecting that bandwidth is the narrowness of the bandwidth of the amplifying active medium 130. Likewise, the narrowness of the bandwidth of the tunable filter 178 affects the output bandwidth. Actually, random noise provided by the active medium 130 in the signal 177c may provide the signal that will eventually be narrowed by the filter 178. That signal band from a noise spectrum may be relied upon for the seeding process of the signal 177f fed to the photonic source 12.

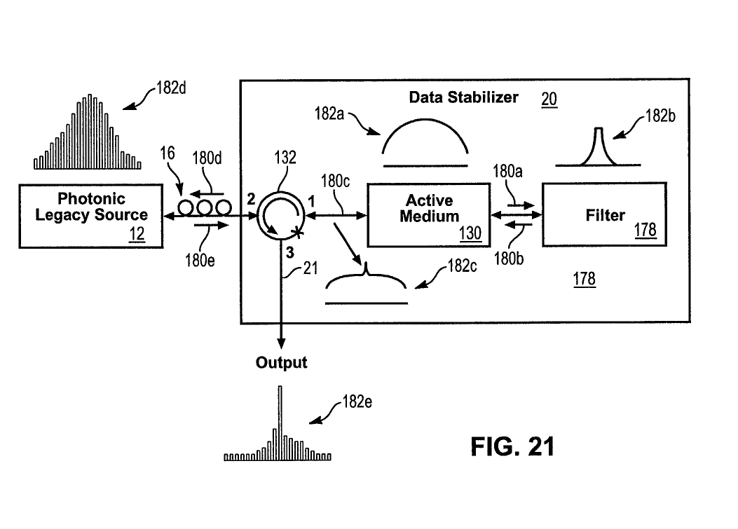

Referring to FIG. 21, the noise effects of the active medium 130 are illustrated in yet another embodiment. In the illustrated embodiment, the active medium 130 provides broadband noise to a filter 178. For example, the signal 180a passes from the active medium 130 to the filter 178. Meanwhile, the filter 178 reflects a narrowed bandwidth in the signal 180b. For example, the spectrum of the active medium 130, as it would exist without feedback of any type, may be reflected by a spectral distribution corresponding to the schematic graph 182a.

By contrast, the signal 180b as reflected by the filter 178 may have a spectral distribution characterized by the spectral graph 182b. Due to the reflection of the signal 180b from the filter 178, the active medium 130 is predisposed to the narrowed band corresponding to the spectral graph 182b.

Accordingly, the output 180c from the active medium 130 has a spectral distribution characterized schematically by the spectral graph 182c. Certain of the broadband characteristics of the original, unmitigated, spectral graph 182a may be seen in the shape of the spectral graph 182c. However, the high, narrow spike presented by the spectral graph 182b is also characteristic of the center portion of the spectral graph 182c characterizing the output signal 180c.

The output signal 180c, if passed by the circulator 132 as a signal 180d to the legacy photonic source 12 without feedback, would have a spectral distribution illustrated by the graph 182d. That is, without the externally provided signal 180d as a seed reference, the spectral distribution of the legacy photonic source 12 would be characterized schematically by the spectral graph 182d. However, in the presence of the signal 180d, the legacy photonic source 12 provides an output 180e to the circulator 132 having a characteristic spectral distribution illustrated schematically in the spectral graph 182e. Accordingly, the output 21 of the circulator 132 is characterized by a comparatively narrower, collapsed, spectral distribution, while still containing the substantive information modulated onto the legacy photonic source 12.

Significantly, the data stabilizer 20, constituted by the active medium 130, circulator 132, and filter 178 is on the end of the transmission medium 16 opposite that of the photonic source 12. The seeding process of the data stabilizer 20 in controlling the legacy photonic source 12 is executed remotely seeding need not have the explicit cooperation of the legacy photonic source 12. So long as the photonic source 12 is not provided with an isolator, the signal 180d may be fed back effectively upstream to the source 12, by the data stabilizer 20. A legacy source 12, remote and non-cooperating, so long as not isolated, may be seeded to produce the narrower band output 21, stabilized as desired.

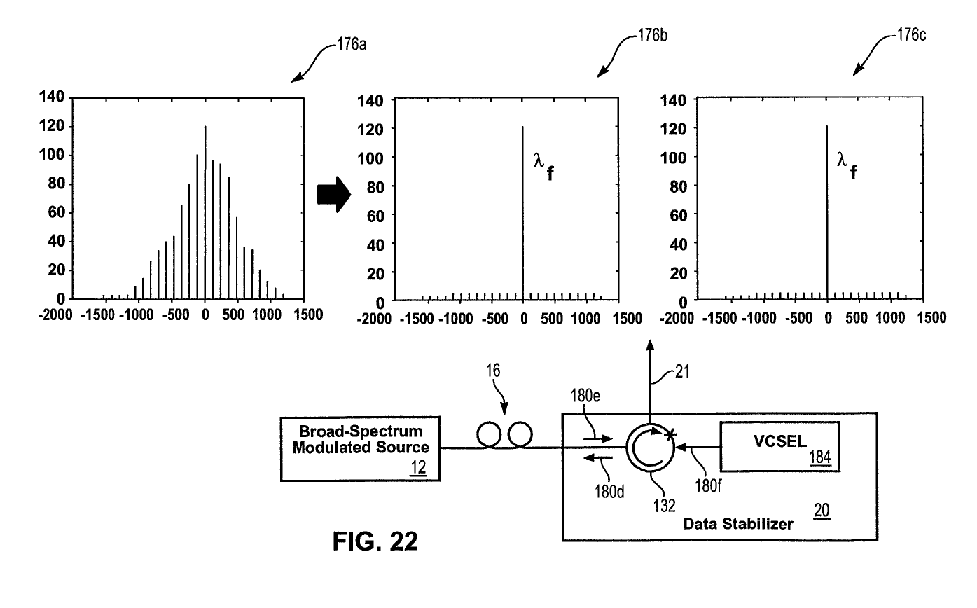

Referring to FIG. 22, a data stabilizer 20 may rely on a VCSEL (vertical cavity surface emitting laser) 184 in lieu of the combination of the active medium 130 and associated filter 178 illustrated in FIG. 21. In the instant embodiment, the VCSEL 184 provides the spectral characteristics of the broad-spectrum, modulated photonic source 12. These characteristics are illustrated in the graphs 176a, 176b corresponding to the unmitigated state and the feedback-controlled state, respectively.

Meanwhile, the signal 180f from the VCSEL 184 to the circulator 132 is ultimately passed as the signal 180d to the photonic source 12. The signal 180d operates to seed the photonic source 12, resulting in an output therefrom as a signal 180e to the circulator 132. The circulator 132, with minimal characteristic losses, passes the signal 180e out as the output signal 21. The output 21 is accordingly stabilized by the data stabilizer 20. The output 21 has a characteristic spectral distribution illustrated schematically in the graph 176c, and corresponding to the graph 176b in characteristic narrowbandedness.

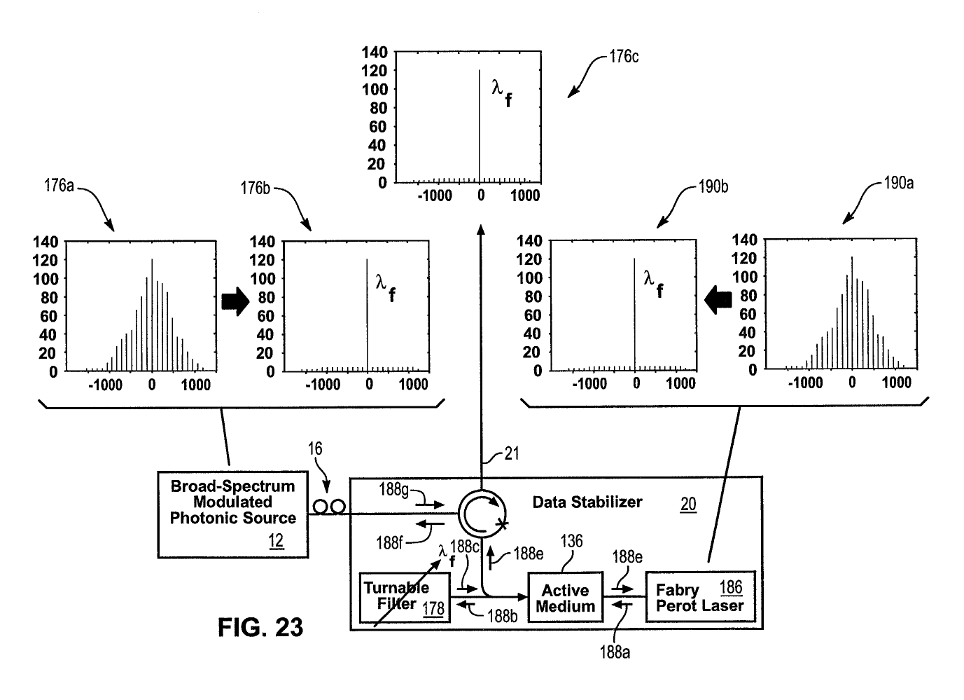

Referring to FIG. 23, a date stabilizer 20 may be implemented remotely on a broad-spectrum modulated photonic source 12. That is, the data stabilizer 20 is positioned on an end of the carrier medium 16 opposite that of the photonic source 12. In the illustrated embodiment, the spectral characteristics of the photonic source 12 in the absence of feedback or seeding is characterized by the graph 176a, while the feedback or seeded characteristic as modified for the output signal 14 is characterized by the spectral graph 176b.

In the illustrated embodiment, data stabilization of the data stabilizer 20 is initiated by a source 186, which duty may effectively be served by a Fabry Perot laser 186. The spectral characteristic of the Fabry Perot laser 186 is illustrated by the spectral graph 190a, if unmodified by other features of the data stabilizer 20. The output signal 188a from the Fabry Perot laser 186 passes to an active medium 130. The active medium 130 provides a signal 188b to a tunable filter 178.

The tunable filter, if selected to have a narrowbanded reflective spectrum without the tuning range of the Fabry Perot laser 186, returns a signal 188c to the active medium 130. The signal 188c is effective to narrow the spectrum of the Fabry Perot laser 186. That is, the signal 188d from the active medium is influenced by the signal 188c to effectively narrow the bandwidth thereon. Accordingly, the signal 188d, when fed back into the Fabry Perot laser 186, results in an effective narrowing of the bandwidth of the output signal 188a therefrom. Thus, the spectral graph 190b characterizes the signal 188a from the Fabry Period laser 186, when properly interacting with the active medium 130, as well as signals 188b, 188c corresponding to the tunable filter 178.

The signal 188b from the active medium 130 may be sampled as a signal 188e directed to a circulator 132. Therefore, the circulator 132 is configured to provide a “seedback” signal 188f to the broad-spectrum photonic source 12. Thus, the spectral distribution of the output 14 from the photonic source 12 is characterized by the spectral graph 176b. The output 12 is directed toward the transmission medium 16, ultimately arriving as the signal 188g at the circulator 132.

Thus, the output 21 from the stabilizer 20 is characterized by a comparatively narrowband spectral distribution illustrated in the spectral graph 176. The output 21 contains the modulated information originated from the photonic source 12. Meanwhile, the photonic distribution of the signal 21 is characterized by the narrowbanded spectral distribution desired.

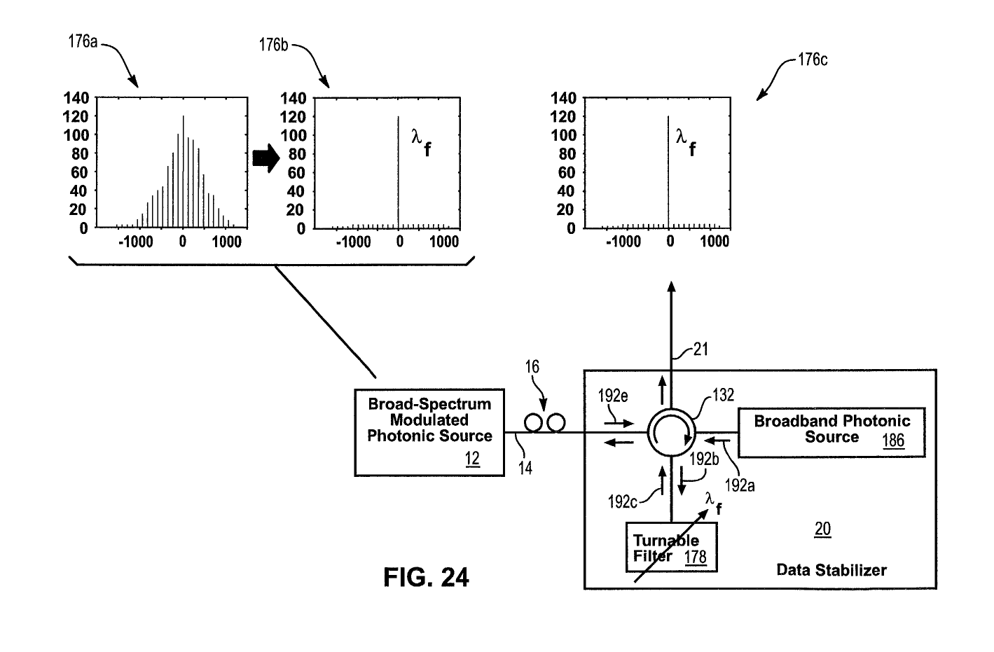

Referring to FIG. 24, a comparatively inexpensive mechanism for implementing a data stabilizer 20 may rely on an inexpensive source 186. For example, light emitting diodes may provide laser light having a comparatively broadband spectrum. Nevertheless, using the combination of a circulator 132 and a filter 178, the data stabilizer 20 may provide a stabilized output 21 having a comparatively narrow spectral distribution.

Again, the data stabilizer 20 may be located remotely from the broad-spectrum, modulated, photonic source 12, at an opposite end of the carrier medium 16. The photonic source 12, if not provided feedback or seedback would have a spectral distribution characterized by the spectral graph 176a. However, being provided with the narrowed feedback from the data stabilizer 20, the characteristic spectral distribution of the graph 176b is provided as the output 14 from the photonic source 12.

In operation, the signal 192a from the source 186 is passed by a circulator 132 into a tunable filter 178 as the signal 192b. The tunable filter 178 narrows the band of the signal 192b, outputting a narrowband signal 192c. The circulator 132 passes the narrowband signal 192c into the photonic source 12 as the input signal 192d. Thus, the input signal 192d predisposes the photonic source 12 to the narrowbanded characteristic of the signal 192d. Accordingly, the signal 14 ultimately becomes the stabilized signal 192e provided to the circulator 132 and ultimately output as the signal 21.

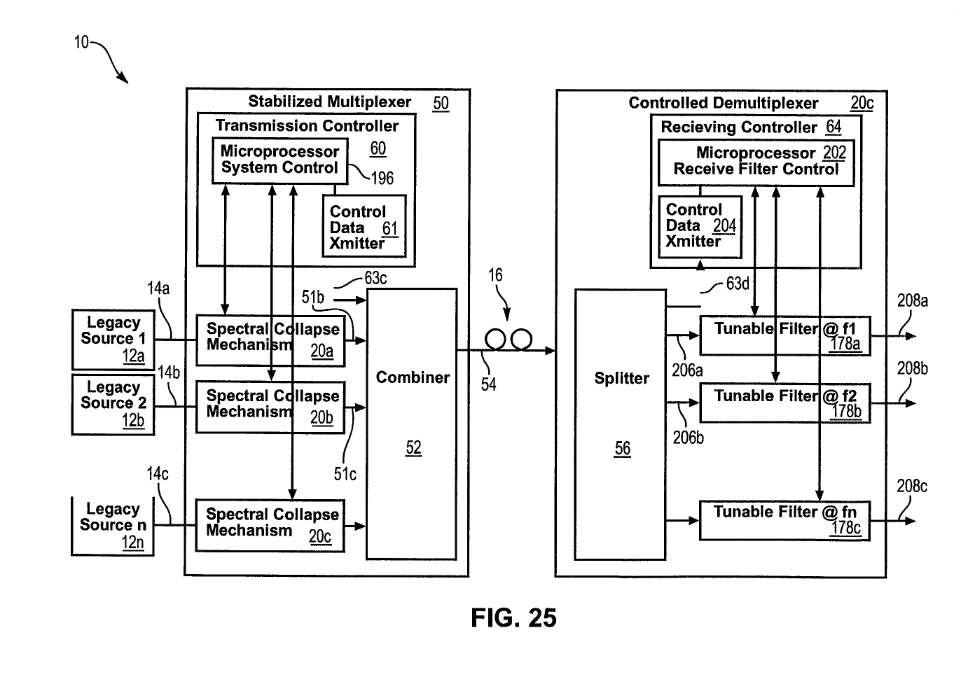

Referring to FIG. 25, an apparatus 10 may benefit from microprocessors 196, 202 for controlling, sending, and receiving data. In the illustrated embodiment, a control data transmitter 61 from a controller 60 may provide outputs 63c resulting in a signal 63d received by a control data receiver 204 at the receiving end of the system. Accordingly, after filtering of outputs 206 from a splitter, the outputs 208 may be provided to destination equipment 36. In general, a demultiplexer 48 may be implemented in a variety of configurations. In the illustrated embodiment, the controlled demultiplexer 200 relies on the microprocessor 202 in order to control the channel allocation of signals 206 as outputs 208.

In operation, the stabilized demultiplexer 50 may receive signals 14 from legacy sources 12. Each of the signals 14 is received into a stabilizer 20, which may benefit from a spectral collapse mechanism embodied therein. The output signals 51 from the stabilizers 20a are fed to a combiner 52. The combiner 52 is responsible for combining all of the signals 51 into an output 54 directed to a transmission medium 16 and ultimately to a controlled demultiplexer 200 or other multiplexer 48.

The addition of a transmission controller 60 facilitates individualized control of each of the stabilizers 20 to provide channel allocation. Control may even be tailored to match the particular wavelength of an output 51 in order to optimize the benefits or the cooperation with the spectral characteristic of the legacy source 12. Accordingly, any experience with individual sources 12a, 12b, 12c, up through any number of legacy sources 12n may be a matter of understanding the characteristic of the source 12, rather than necessarily controlling the characteristics of the source.

Spectral collapse is a very beneficial mechanism. However, allocating a particular central wavelength around which to collapse the spectrum of a legacy source 12 is an important consideration. The controller 60 may be configured to allocate particular portions of the available spectrum to each of the stabilizers 20, in accordance with the inherent characteristics (e.g. preferred wavelengths or modes) of disparate legacy sources 20a. Thus, rather than trying to force a particular legacy source to perform at an enforced wavelength, the controller 60 may select a wavelength already well suited to the performance of the legacy source 12.

In certain embodiments, the controller 60 may operate fully photonically. However, in other embodiments, a microprocessor 196 may provide the programmatic control of the various data stabilizers 20. Meanwhile, the control data transmitter 61 of the controller 60 feeds forward a signal 63c, which is also entered into the combiner 52 with the substantive data signals 51. The multiplexed signal 54 output from the combiner into the stabilized multiplexer 50 embodies not only the substantive data, but a feed-forward control signal 63c embedded therein. Upon receipt, by the splitter 56, of the signal 54, the splitter 56 outputs the separated signals 206 directed to the respective tunable filters 178.

Meanwhile, the signal 63c, or more properly, the informational content therein, is passed in the signal 54 to the splitter 56. The splitter subsequently separates out a signal 63d directed to a control data receiver 204 in the receiving controller 64. The receiving controller 64, in turn, includes a received filter control 202, which may be a microprocessor-based controller 202. In accordance with the information embodied in the signal 63d, the microprocessor 202 operates to provide control information to each of the tunable filters 178.

Controlling information may include, for example, data in accordance with the programming of the microprocessor 202. Controlling information may instruct any one of the tunable filters 178 to isolate a single channel, or a band of channels, in order to provide channel allocation among the output signals 208. In selected embodiments, the microprocessor 202 may instruct the tunable filters 178 in order to effect channel allocation, provisioning, finely tuned tracking of the original sources 12, or even re-allocation of channel bandwidths to fit the fixed requirements of particular legacy destination equipment 36.

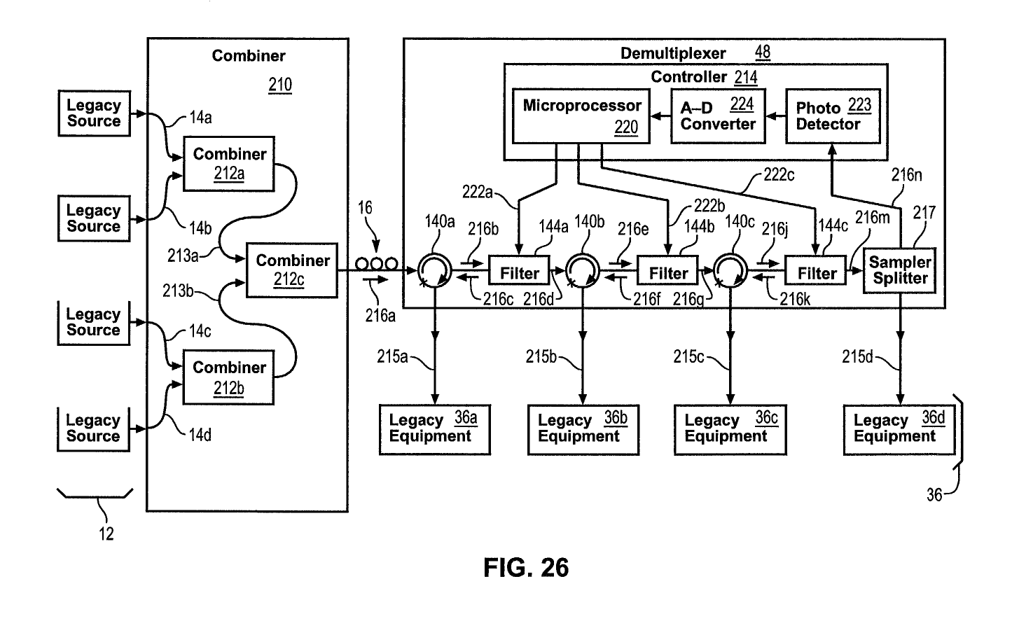

Referring to FIG. 26, an alternative embodiment of an apparatus 10 or system 10 may include a variety of legacy sources 12 feeding into a combiner 52 in order to service a demultiplexer 48 outputting to legacy equipment 36. In the illustrated embodiment, the combiner 52 may include a simplified combiner 210 made up of several combiners 212 cascading together to consolidate signals 14 into intermediate signals 213. Ultimately the signals 213 combine into an output signal 216a directed to a carrier medium 16 or transmission medium 16 connecting to the demultiplexer 48.

The demultiplexer 48 may be provided with a controller 214 configured to assert control over a configuration of tunable filters 144. Ultimately, the combination of circulators 140 and filters 144 results in channel selection or channel allocation as well as channel separation for the individual signals 215 output by the demultiplexer to the legacy equipment 36. Thus, the controller 214 is effective to define for the demultiplexer 48 the separation and allocation of information and wavelength among the various signals 215 being output therefrom.

The input 216a into the demultiplexer 48 is received by a circulator 140a, which passes the information of the signal 216a, to a filter 144a as an input signal 216b. The filter 144a, having reflective properties as well as bandpass properties, reflects a signal 216c to the circulator 140a. The signal 121b will ultimately be output as the output signal 215a to the legacy equipment 36a illustrated. Meanwhile, the bandpass characteristic of the filter 144a passes a signal 216d to a circulator 140b in which a similar process is repeated. That is, the signal 216dis passed to the filter 144b as a signal 216e, the reflected signal 216f returning to the circulator 140b to be output as the output signal 215b to the legacy equipment 36b.

By the same token, the filter 144b, passing a portion of the signal 216e to the circulator 140c as the signal 216g, repeats the entire process again to produce the output signal 215c. The remaining portion of the signal 216j, not reflected as the signal 216k, produces a signal 216m passed from the filter 144c to a sampler splitter 217. The sampler splitter provides signals 215d as an output to legacy equipment 36d. A sampled portion of the energy of the signal 216m is diverted by the sampler splitter 217 as a signal 216n to a photodetector 223. Typically, the energy of the sampled portion embodied in the signal 216n is significantly less than the energy devoted to the signal 215d.

The photodetector 223 provides an output 218a, corresponding to the information in the signal 216n, to an analog-to-digital converter (ADC) 224. The output 218b from the ADC 224 provides to the microprocessor 220 information that may be interpreted programmatically by the microprocessor 220. The microprocessor 220 uses the information to determine what control to assert through the signals 222.

In the illustrated embodiment, no feed forward is explicitly illustrated. Such an embodiment is possible, however, through the signal 216a. Utilizing one or more of the legacy sources 12, the sampler splitter 217 may simply use the substantive information processed by the circulators 140 and the filters 144. Thus, the signal 216n simply reflects the reality of the status of the demultiplexer 48. The microprocessor 220 may be programmed to operate on data reflecting that reality in order to assert the control through the signals 222.

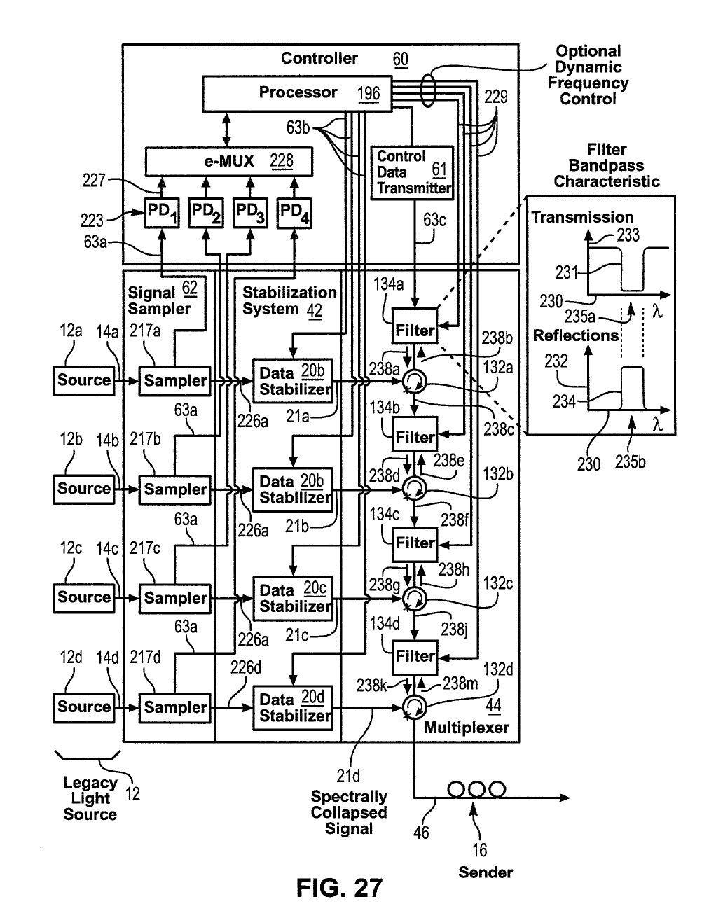

Referring to FIG. 27, a number of legacy photonic sources 12 feed signals 14 into a stabilized multiplexing system 40. The stabilized multiplexing system 40 includes a signal sampler 62 providing signals 226 to data stabilizers 20. The data stabilizers 20 provide outputs 21 into a multiplexer 44. The multiplexer 44 is controlled by a controller 60. The programmatic control asserted by the controller 60 facilitates the multiplexer 44 producing a stabilized multiplexed signal 46 directed toward the carrier medium 16.

The controller 60 includes detectors 223 configured to receive control signals 63a from the signal sampler 62. Outputs 227 sent from the detectors 223 into the electronic multiplexer 228 provide control information to the processor 196. Incidently, each of the detectors 223 may be a photonic detector 223, and in certain embodiments may be implemented in the form of a photodetector.

Each of the filters 134 has a characteristic bandpass and a characteristic bandwidth. Each of the photonic filters 134 may be characterized by it's photonic spectral characteristic displayed on a wavelength axis 230 along with a transmission axis 231, in conjunction with a reflection axis 232. The transmission curve 233 demonstrates the relative photonic transmission of the photonic filter 134 with respect to a particular incoming signal 238. The signal transmission is not the same in each direction. For an incoming signal, the filtering process provides band pass of certain wavelengths in one direction and reflection of other wavelengths in the opposite direction. Filter 134 typically behaves the same regarding which wavelengths are reflected and which wavelengths are passed, regardless of the direction of input of the incoming signal 238. Other filtration mechanisms may be used. However, in certain presently preferred embodiments, an apparatus 40 in accordance with the invention benefits from filters as described.

For a region of interest 235 along the wavelength domain, the transmission curve 233 and the reflection curve 234 demonstrate how, a selected narrow band is reflected, rather than transmitted. This characteristic reflection applies to any signal 238 impinging on the filter 134. Elsewhere, outside the region of interest 235, the signal 238 is transmitting through the filter 134.

As a practical matter, infinite bandwidth is not possible. As a result, the filter 134 may be regarded as a bandpass filter for those portions transmitted outside the wavelength region of interest 235, and may be regarded as a reflective filter for wavelengths within the range of interest 235. Other types of filters may be used as the mechanisms for the filters 134, but the illustrated embodiment capitalizes on certain transmission efficiencies, as well as the ability to use the bandpass portion of a spectral range of a signal 238.

In operation, the apparatus 40 operates by receiving input signal 14 from legacy photonic sources 12 or other photonic sources 12. Each source 12 supplies a signal 14 to a sampler 217, which forwards a control information signal 63 to a detector 223. Meanwhile, the sampler 217 forwards to each data stabilizer 20 in a stabilization system 42 a signal 226 containing the information modulated by the photonic source 12.

The output 21 associated with each data stabilizer 20 is controlled by the data stabilizer 20 in accordance with a control signal 63 received from the processor 196. The processor 196 is operating on data received from an electronic multiplexer 228. The electronic multiplexer 228, in turn, is operating to combine data in signals 227 received from detectors 223. The detectors 223 have received photonic inputs from the respective samplers 217, forwarded through the signals 63a to the detectors 223.

Each of the signals 21 is transmitted from a data stabilizer 20 into a respective circulator 132. In contrast to the embodiment of FIG. 26, the embodiment of FIG. 27 operates to filter and to add in a signal at each stage of the circulator 132 and corresponding filter 134. This mode is used rather than operating to pick off or extract a particular signal with each circulator 140 and corresponding filter 144 (see FIG. 26). Meanwhile, the control signals 229 from the processor 196 of the controller 60 are transmitted to the tunable filters 134. Similarly, a control signal 63c is transmitted from the control data transmitter 61, out of the processor 196, to the first filter 134a. In accordance with the bandpass filter characteristics 233, 234, a portion of the signal 63c is reflected, and a portion is passed.

The incoming signal 21a to the circulator 132a is redirected to become the signal 238a into the filter 134a. The reflected portion 238b is returned to the circulator 132a to be transmitted as the signal 238c into the next filter 134b. The signal 238b includes both the portion of the signal 21a that is reflected by the filter 134a, as well as the portion of the signal 63c that was transmitted by the filter 134 into the signal 238b.

The process is repeated for the signal 21b proceeding from the data stabilizer 20b and provided to the circulator 132b. Accordingly, the signal 238d constitutes the substantive content of the signal 21b. The return signal 238e reflected from the filter 134b includes both the reflected component of the signal 238d input thereto as well as the transmitted portion of the signal 238c input into the filter 134b.

The process can be further extended to the signals 21c, 238g, 238f, and 238h, resulting in the output 238j from the circulator 132c input into the filter 134d. Ultimately, the signals 21d, 38k, 238m interact between the data stabilizer 20b, the circulator 132d and the filter 134d to produce the output signal 46. The output signal 46 is a stabilized, multiplexed, photonic signal directed to the carrier medium 16 and some ultimate destination 36.

The control signal 63c, with each residual transmitted portion thereof in the corresponding signals 238b, 238c, 238e, 238d, 238h, 238j, 238m, and ultimately the signal 46, may serve to transmit through the multiplexer 44 the controlled data intended for control of the demultiplexer 48 at an opposite end of the carrier medium 16 or transmission medium 16. Meanwhile, the processor 196 sends control signals 229 to each of the filters 134 in order to assure that no two filters 134 have identical regions 235.

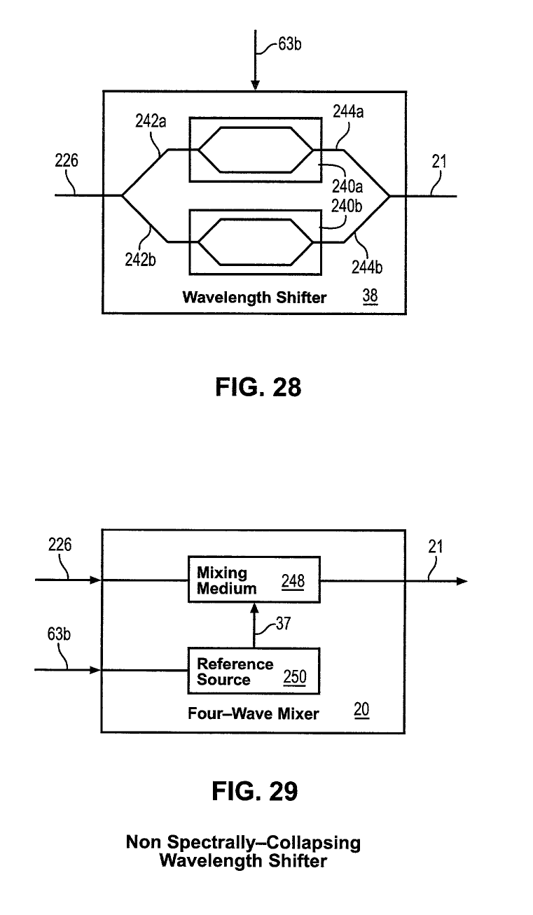

Referring to FIG. 28, one embodiment of a data stabilizer 20 may rely on a wavelength shifter 38. In the illustrated embodiment, the wavelength shifter 38 may include a pair of Mach Zehnder modulators 240. In combination, the Mach Zehnder modulators 240 become part of a larger or composite Mach Zehnder modulator 38. Thus, this Mach Zehnder modulation 38 becomes a wavelength shifter 38.

In operation, the wavelength shifter 38 receives a signal 226, which is split by a splitter into two substantially equivalent signals 242a, 242b. Differences in phase there between may be accommodated, but the intensities and information in each of the signals 242a, 242b are typically equivalent. The wavelength shifter 38 receives a control signal 63b, used to control the modulation accomplished by each of the Mach Zehnder modulators 240. This signal 63b may come in the form of multiple connections, multiple lines, and the like, in order to accomplish the task of feeding control information to each of the Mach Zehnder modulators 240.

Following modulation by the Mach Zehnder modulators 240, the signals 240a, 240b, are passed on as signals 244a, 244b, respectively. A combiner combines the signals 244a, 244b into an output signal 21 that is now wavelength shifted toward a particular wavelength desired. This effectively separates, within the spectral domain, the desired information carried in the output signal 21. That is, each of the output signals 21 of the individual data stabilizers 20 (and the corresponding original sources 12) needs to be isolated within the wavelength domain according to the requirements to avoid cross-talk.

Wavelength shifting by a wavelength shifter 38 provides a degree of control over an otherwise uncontrolled bandwidth of a legacy source. In combination with the filtration provided by the filters 134, the wavelength shifter 38, need only operate in a comparatively narrow band, and shift signals from that band, allowing the rest to be filtered away. Thus, the wavelength shifter 38 may also serve as a cleanup mechanism, by passing only selected ranges of wavelengths. Meanwhile, anything that was unshifted is simply filtered away by subsequent elements of the apparatus 40.

As discussed hereinabove, the wavelength shifter 38 may be used in combination with other types of elements in order to accomplish the data stabilization function of any given design of a data stabilizer 20. For example, wavelength shifting 38 may be used in combination with spectral collapse, seeding, and the like.

Referring to FIG. 29, one embodiment of a data stabilizer 20 may be a four-wave mixer 20. Typically, by careful selection of the reference source 250. One may select the operational wavelength thereof. The signal 37 sent to the mixing medium 248 is thus controlled in accordance with the wavelengths corresponding to the reference sources 253. Typically, an input signal 226 may include a particular characteristic frequency. Meanwhile, the reference source 50, and the signal 37 output therefrom have a characteristic frequency. The mixing medium 248 mixes each of the signals 226, 37, producing a combination of the wavelength of the signal 226, the wavelength of the signal 37, the difference between the wavelengths, and the sum of the wavelengths.

By suitable choice of the reference source 250 (suitable selection of the wavelength thereof), a desired wavelength may be imposed on the output signal 21. Moreover, the signal 36b, if used with a source 250 that is tunable, may permit dynamic selection of the wavelength of the signal 21. Meanwhile, the four-wave mixer 20 may be used in combination with any of the other mechanisms, such as a wavelength shifter 38 or other spectral collapse device, seedback, or their phenomena to effect the operation of data stabilizers 20.

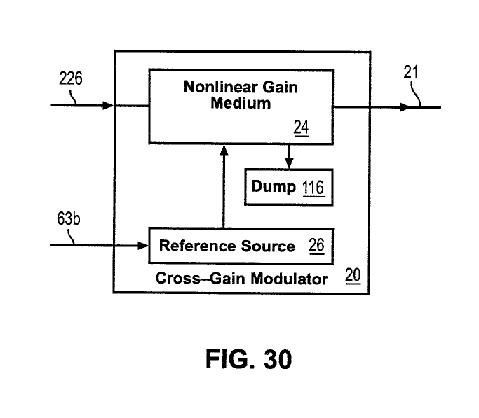

Referring to FIG. 30, a signal 226 may be provided into a cross-gain modulator 20 operating as a data stabilizer 20 alone, or in combination with other mechanisms. In the illustrated embodiment, a non-linear gain medium 24 receives a signal 226, and dumps a portion thereof overboard into a dump 116. Meanwhile, a signal 63b controls a reference source 26 providing a signal 28 into the non-linear gain medium 24.

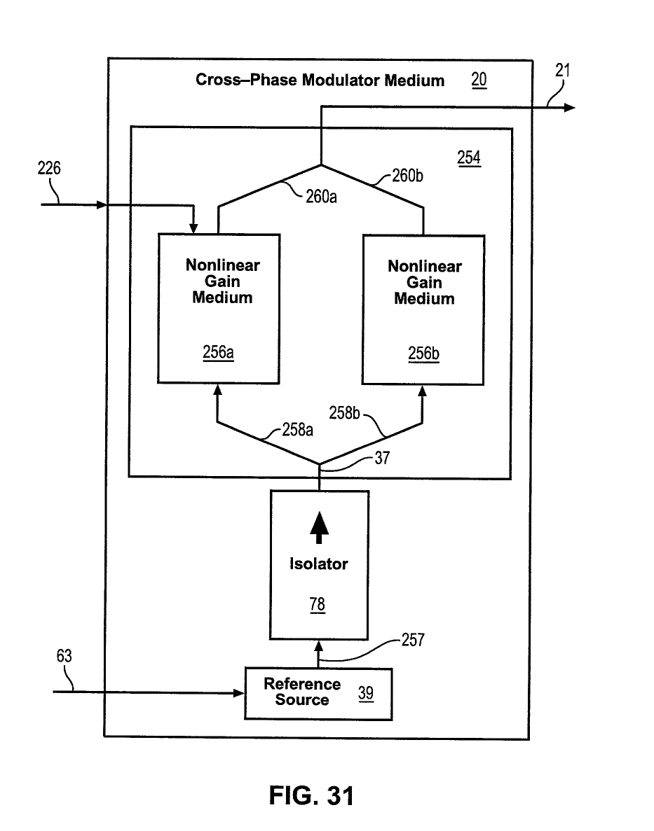

In contrast to the embodiments of FIGS. 28, 29, the cross-gain modulator 20 of FIG. 30 is a spectrally-collapsing wavelength shifters. By contrast, the former embodiments are nonspectrally-collapsing wavelength shifter. Likewise, the latter device of FIG. 30, as well as the device of FIG. 31, are spectrally-collapsing, wavelength shifters 20. The cross-gain modulator 20 operates by modulating the information from the signal 226 onto the signal 28 from the reference source, resulting in a narrowed, stabilized bandwidth for the signal 21 output therefrom.

Referring to FIG. 31, a data stabilizer 20 may be embodied as a cross-phase modulator 20. In the illustrated embodiment, an input signal 226 embodying the modulated data and an input signal 63 embodying control information are provided as inputs to the modulator 20. The signal 226 is fed into a Mach Zehnder arrangement of a two non-linear gain-medium elements 256. The control signal 63 controls a reference source 39 providing a signal 257 to the Mach Zehnder device 254, typically through an isolator 78.

The signal 37 output from the reference source 39, as isolated, is divided substantially equally into the inputs 258a, 258b directed toward the non-linear gain media 256. The non-linear gain medium 256a is modulated in accordance with the data of the signal 226. That is, the refractive index of the non-linear gain medium 256a is modulated, thereby changing, due to the influence of the modulated signal 226. Accordingly, the signal 260a encounters a phase shift with respect to the signal 260b that passes through the non-linear gain medium 256b without the influence of the modulated signal 226b.

Consequently, upon combination of the signals 260a, 260b, the effective bandwidth of the signal 21 has been narrowed. Therefore, the output signal 21 is a spectrally collapsed, wavelength-shifted signal 21. The signal 21 contains the information modulated into the signal 226, but operates at the wavelength corresponding to the signal 257 from the reference source 239.

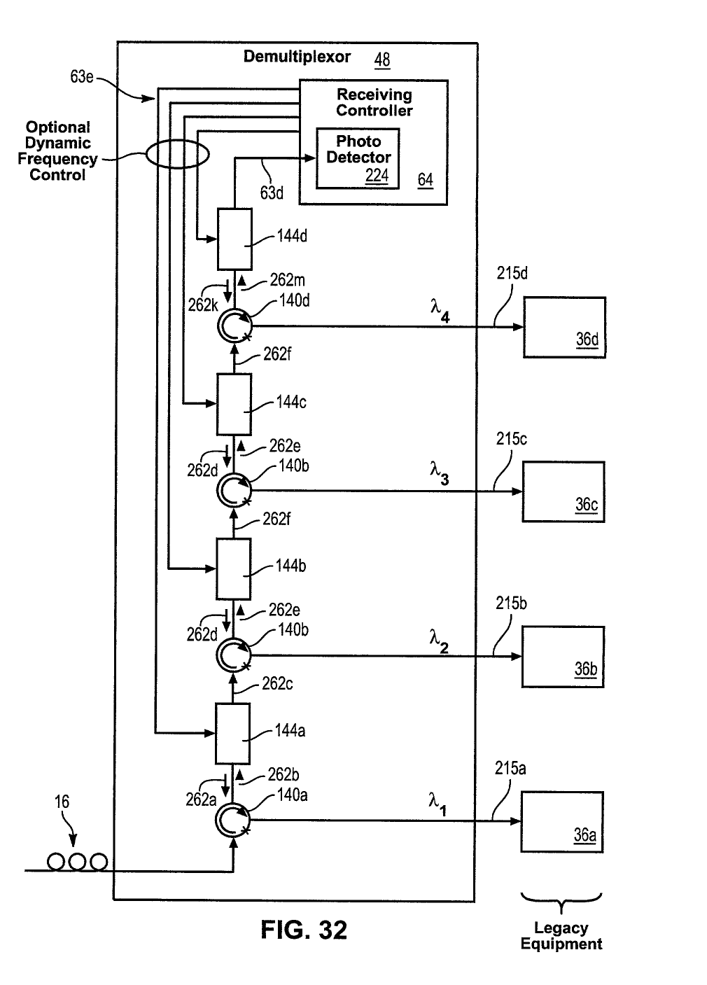

Referring to FIG. 32, an entire channel from the input, and subsequently a complete channel allocation from the outputs, may be dedicated to the function of control. That is, rather than taking a sample, or otherwise dividing out a portion of the energy of a particular signal, in order to provide feedback or feed forward, controlled data may simply be transmitted as one substantive channel of data.

See FIG. 27 is one embodiment of the corresponding portion from the transmitting end, while FIG. 32 corresponds to the receiving end.

In the embodiment illustrated in FIG. 32, a receiving controller 64 receives a signal 63d as a substantive signal from a filter 144d. In accordance therewith, the receiving controller asserts control over the signals 63e forwarded to the individual filters 144. In this embodiment, one of the channels, and thus one of the available wavelengths (e.g. bands, etc.) assigned for transmission of substantive data is dedicated to carrying the signal 63d over the carrier medium 16 and into the demultiplexer 48.

From the above discussion, it will be appreciated that the present invention provides a data stabilizer by one of several methods. The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed and desired to be secured by United States Letters Patent is:

1. An apparatus for spectral taming by spectral collapse, the apparatus comprising:
an active medium configured to provide a photonic signal having a first spectral bandwidth and a first spectral distribution;
a circulator configured to provide the photonic signal to a tunable, reflective filter;
the tunable reflective filter configured to collapse the spectral bandwidth to a second spectral distribution within and less than the first spectral distribution, and having a second spectral bandwidth less than the first spectral bandwidth;
a legacy photonic source operably connected to receive the photonic signal from the tunable reflective filter, through the circulator, and to provide to the circulator a narrowband signal corresponding to the photonic signal and modulated with information; and
the active medium, further configured to receive the narrowband signal from the legacy photonic source, through the circulator, and to amplify the narrowband signal to produce a modulated output signal embodying the information.

2. A method for spectral taming by spectral collapse, the method comprising:
providing from an active medium a photonic signal having a first spectral bandwidth and a first spectral distribution;
directing the photonic signal from the active medium, through a circulator, and to a tunable, reflective filter;
collapsing the first the tunable reflective filter configured to collapse the first spectral bandwidth to a second spectral distribution within and less than the first spectral distribution, and having a second spectral bandwidth less than the first spectral bandwidth;
providing a legacy photonic source operably connected to receive the photonic signal from the tunable reflective filter, through the circulator, and to provide to the circulator a narrowband signal corresponding to the photonic signal and modulated with information; and
directing to the active medium the narrowband signal from the legacy photonic source, through the circulator; and
amplifying the narrowband signal to produce a modulated output signal embodying the information and having an output spectral bandwidth substantially less than the first spectral bandwidth.
